(19) United States
(12) Patent Application Publication
(10) Pub. No.: US 2024/0240038 A1
(43) Pub. Date: Jul. 18, 2024

(54) ELECTRODEPOSITABLE COATING COMPOSITIONS

(71) Applicant: PPG Industries Ohio, Inc., Cleveland, OH (US)

(72) Inventors: Brian Carl Okerberg, Gibsonia, PA (US); David Alfred Stone, Allison Park, PA (US); Derek James Saxon, Appleton, WI (US); Christophe R.G. Grenier, Pittsburgh, PA (US); Ross Anthony Moretti, Pittsburgh, PA (US)

(73) Assignee: PPG Industries Ohio, Inc., Cleveland, OH (US)

(21) Appl. No.: 18/571,772

(22) PCT Filed: Jul. 1, 2022
(86) PCT No.: PCT/US2022/073344

§ 371 Date: Dec. 19, 2023

Related U.S. Application Data
(60) Provisional application No. 63/217,547, filed on Jul. 1, 2021.

(51) Int. Cl. C09D 5/44

(52) U.S. Cl. CPC C09D 5/4442; C09D 5/4453; C09D 5/4457

(57) ABSTRACT

The present disclosure is directed to an electrodepositable coating composition comprising a hydroxyl-functional addition polymer comprising constitutional units, at least 70% of which comprise formula (I): —[—C(R¹)₂—C(R¹)(OH)—]— (I), wherein each R¹ is independently one of hydrogen, an alkyl group, a substituted alkyl group, a cycloalkyl group, a substituted cycloalkyl group, an alkylcycloalkyl group, a substituted alkylcycloalkyl group, a cycloalkylalkyl group, a substituted cycloalkylalkyl group, an aryl group, a substituted aryl group, an alkylaryl group, a substituted alkylaryl group, a cycloalkylaryl group, a substituted cycloalkylaryl group, an arylalkyl group, a substituted arylalkyl group, an arylcycloalkyl group, or a substituted arylcycloalkyl group; an ionic salt group-containing film-forming polymer comprising active hydrogen functional groups; a blocked polyisocyanate curing agent comprising blocking groups, wherein the blocking groups comprise a 1,2-polyol as a blocking agent; and a bismuth catalyst.

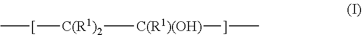

### CROSS-REFERENCE TO RELATED APPLICATIONS

This application claims the benefit of U.S. Provisional Patent Application Ser. No. 63/217,547, filed on Jul. 1, 2021, which is incorporated herein by reference.

### FIELD

The present disclosure is directed towards an electrodepositable coating composition, treated substrates and methods of coating substrates.

### BACKGROUND

Electrodeposition as a coating application method involves the deposition of a film-forming composition onto a conductive substrate under the influence of an applied electrical potential. Electrodeposition has gained popularity in the coatings industry because it provides higher paint utilization, outstanding corrosion resistance, and low environmental contamination as compared with non-electrophoretic coating methods. Both cationic and anionic electrodeposition processes are used commercially. Blocked polyisocyanate curing agents are often used in electrodepositable coating compositions to effectuate cure of the coating once applied. Upon the application of external energy, such as heating, a blocking agent used to reversibly “block” the isocyanato groups of the blocked polyisocyanate curing agent is removed allowing the isocyanato groups to react with a polymeric binder resin and crosslink and cure the coating. Heating is often employed to remove blocking agents from a blocked isocyanato groups of the blocked polyisocyanate curing agent. Heating requires significant energy costs. Previous blocked polyisocyanate curing agents that unblock at relatively low temperatures have been difficult to make, are toxic, or are crystalline and difficult to handle. Additionally, while catalyst may be used to reduce the curing temperature of the coating composition, tin and lead catalysts have been subjected to a number of regulatory restrictions by various countries due to environmental concerns. Therefore, coating compositions that cure at low temperatures utilizing a non-tin and non-lead catalyst with a blocked polyisocyanate curing agent is desired.

### SUMMARY

The present disclosure provides an electrodepositable coating composition comprising a hydroxyl-functional addition polymer comprising constitutional units, at least 70% of which comprise formula I:

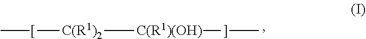

wherein each R¹ is independently one of hydrogen, an alkyl group, a substituted alkyl group, a cycloalkyl group, a substituted cycloalkyl group, an alkylcycloalkyl group, a substituted alkylcycloalkyl group, a cycloalkylalkyl group, a substituted cycloalkylalkyl group, an aryl group, a substituted aryl group, an alkylaryl group, a substituted alkylaryl group, a cycloalkylaryl group, a substituted cycloalkylaryl group, an arylalkyl group, a substituted arylalkyl group, an arylcycloalkyl group, or a substituted arylcycloalkyl group; an ionic salt group-containing film-forming polymer comprising active hydrogen functional groups; a blocked polyisocyanate curing agent comprising blocking groups, wherein the blocking groups comprise a 1,2-polyol as a blocking agent; and a bismuth catalyst.

The present disclosure also provides an electrodepositable coating composition comprising an ionic salt group-containing film-forming polymer comprising active hydrogen functional groups, wherein the ionic salt group-containing film-forming polymer comprises a reaction product of a reaction mixture comprising (a) a polyepoxide; (b) di-functional chain extender; and (c) a mono-functional reactant; a blocked polyisocyanate curing agent comprising blocking groups, wherein the blocking groups comprise a 1,2-polyol as a blocking agent; and a bismuth catalyst.

The present disclosure further provides an electrodepositable coating composition comprising a hydroxyl-functional addition polymer comprising at least 70% of the constitutional units comprise formula I:

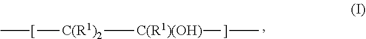

wherein each R¹ is independently one of hydrogen, an alkyl group, a substituted alkyl group, a cycloalkyl group, a substituted cycloalkyl group, an alkylcycloalkyl group, a substituted alkylcycloalkyl group, a cycloalkylalkyl group, a substituted cycloalkylalkyl group, an aryl group, a substituted aryl group, an alkylaryl group, a substituted alkylaryl group, a cycloalkylaryl group, a substituted cycloalkylaryl group, an arylalkyl group, a substituted arylalkyl group, an arylcycloalkyl group, or a substituted arylcycloalkyl group; an ionic salt group-containing film-forming polymer comprising active hydrogen functional groups; a blocked polyisocyanate curing agent comprising blocking groups, wherein the blocking groups comprise a 1,2-polyol as a blocking agent; a bismuth catalyst; and at least one pigment.

The present disclosure further provides a method of coating a substrate comprising electrophoretically applying a coating deposited from an electrodepositable coating composition of the present disclosure to at least a portion of the substrate.

The present disclosure further provides an at least partially cured coating formed by at least partially curing a coating deposited from any electrodepositable coating composition of the present disclosure.

The present disclosure further provides a substrate coated with a coating deposited from the electrodepositable coating composition of the present disclosure.

The present disclosure further provides a coated substrate having a coating comprising (a) a hydroxyl-functional addition polymer wherein at least 70% of the constitutional units comprise constitutional units according to formula I:

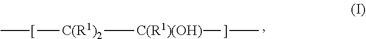

wherein each R¹ is independently one of hydrogen, an alkyl group, a substituted alkyl group, a cycloalkyl group, a substituted cycloalkyl group, an alkylcycloalkyl group, a substituted alkylcycloalkyl group, a cycloalkylalkyl group, a substituted cycloalkylalkyl group, an aryl group, a substituted aryl group, an alkylaryl group, a substituted alkylaryl group, a cycloalkylaryl group, a substituted cycloalkylaryl group, an arylalkyl group, a substituted arylalkyl group, an arylcycloalkyl group, or a substituted arylcycloalkyl group; (b) an ionic salt group-containing film-forming polymer comprising active hydrogen functional groups; (c) a blocked polyisocyanate curing agent comprising blocking groups, wherein the blocking groups comprise a 1,2-polyol as a blocking agent; and (d) a bismuth catalyst.

The present disclosure further provides a coated substrate having a coating comprising (a) an ionic salt group-containing film-forming polymer comprising active hydrogen functional groups, wherein the ionic salt group-containing film-forming polymer comprises a reaction product of a reaction mixture comprising: (i) a polyepoxide; (ii) a polyphenol; and (iii) a mono-functional reactant; (b) a blocked polyisocyanate curing agent comprising blocking groups, wherein the blocking groups comprise a 1,2-polyol as a blocking agent; (c) a bismuth catalyst.

The present disclosure further provides a coated substrate having a coating comprising (a) a hydroxyl-functional addition polymer wherein at least 70% of the constitutional units comprise constitutional units according to formula I:

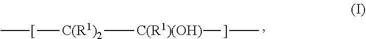

wherein each R¹ is independently one of hydrogen, an alkyl group, a substituted alkyl group, a cycloalkyl group, a substituted cycloalkyl group, an alkylcycloalkyl group, a substituted alkylcycloalkyl group, a cycloalkylalkyl group, a substituted cycloalkylalkyl group, an aryl group, a substituted aryl group, an alkylaryl group, a substituted alkylaryl group, a cycloalkylaryl group, a substituted cycloalkylaryl group, an arylalkyl group, a substituted arylalkyl group, an arylcycloalkyl group, or a substituted arylcycloalkyl group; (b) an ionic salt group-containing film-forming polymer comprising active hydrogen functional groups; (c) a blocked polyisocyanate curing agent comprising blocking groups, wherein the blocking groups comprise a 1,2-polyol as a blocking agent; (d) a bismuth catalyst; and (e) at least one pigment.

The present disclosure also provides a coated substrate having a coating comprising (a) a hydroxyl-functional addition polymer wherein at least 70% of the constitutional units comprise constitutional units according to formula I:

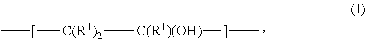

wherein each R¹ is independently one of hydrogen, an alkyl group, a substituted alkyl group, a cycloalkyl group, a substituted cycloalkyl group, an alkylcycloalkyl group, a substituted alkylcycloalkyl group, a cycloalkylalkyl group, a substituted cycloalkylalkyl group, an aryl group, a substituted aryl group, an alkylaryl group, a substituted alkylaryl group, a cycloalkylaryl group, a substituted cycloalkylaryl group, an arylalkyl group, a substituted arylalkyl group, an arylcycloalkyl group, or a substituted arylcycloalkyl group; (b) an ionic salt group-containing film-forming polymer comprising active hydrogen functional groups, wherein the ionic salt group-containing film-forming polymer comprises a reaction product of a reaction mixture comprising: (i) a polyepoxide; (ii) a polyphenol; and (iii) a mono-functional reactant; (c) a blocked polyisocyanate curing agent comprising blocking groups, wherein the blocking groups comprise a 1,2-polyol as a blocking agent; and (d) a bismuth catalyst.

### DETAILED DESCRIPTION

The present disclosure is directed to an electrodepositable coating composition comprising a hydroxyl-functional addition polymer comprising constitutional units, at least 70% of which comprise formula I:

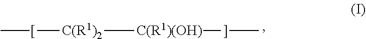

wherein each R¹ is independently one of hydrogen, an alkyl group, a substituted alkyl group, a cycloalkyl group, a substituted cycloalkyl group, an alkylcycloalkyl group, a substituted alkylcycloalkyl group, a cycloalkylalkyl group, a substituted cycloalkylalkyl group, an aryl group, a substituted aryl group, an alkylaryl group, a substituted alkylaryl group, a cycloalkylaryl group, a substituted cycloalkylaryl group, an arylalkyl group, a substituted arylalkyl group, an arylcycloalkyl group, or a substituted arylcycloalkyl group; an ionic salt group-containing film-forming polymer comprising active hydrogen functional groups; a blocked polyisocyanate curing agent comprising blocking groups, wherein the blocking groups comprise a 1,2-polyol as a blocking agent; and a bismuth catalyst.

According to the present disclosure, the term “electrodepositable coating composition” refers to a composition that is capable of being deposited onto an electrically conductive substrate under the influence of an applied electrical potential. As further described herein, the electrodepositable coating composition may be a cationic electrodepositable coating composition or an anionic electrodepositable coating composition.

### Hydroxyl-Functional Addition Polymer

The electrodepositable coating compositions of the present disclosure comprises a hydroxyl-functional addition polymer comprising constitutional units, at least 70% of which comprise formula I:

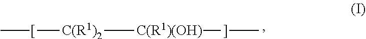

wherein each R¹ is independently one of hydrogen, an alkyl group, a substituted alkyl group, a cycloalkyl group, a substituted cycloalkyl group, an alkylcycloalkyl group, a substituted alkylcycloalkyl group, a cycloalkylalkyl group, a substituted cycloalkylalkyl group, an aryl group, a substituted aryl group, an alkylaryl group, a substituted alkylaryl group, a cycloalkylaryl group, a substituted cycloalkylaryl group, an arylalkyl group, a substituted arylalkyl group, an arylcycloalkyl group, or a substituted arylcycloalkyl group, and the % based upon the total constitutional units of the hydroxyl-functional addition polymer.

Non-limiting examples of suitable alkyl radicals are methyl, ethyl, propyl, isopropyl, n-butyl, isobutyl, tert-butyl, amyl, hexyl, and 2-ethylhexyl.

Non-limiting examples of suitable cycloalkyl radicals are cyclobutyl, cyclopentyl, and cyclohexyl.

Non-limiting examples of suitable alkylcycloalkyl radicals are methylenecyclohexane, ethylenecyclohexane, and propane-1,3-diylcyclohexane.

Non-limiting examples of suitable cycloalkylalkyl radicals are 2-, 3- and 4-methyl-, -ethyl-, -propyl-, and -butylcyclohex-1-yl.

Non-limiting examples of suitable aryl radicals are phenyl, naphthyl, and biphenylyl.

Non-limiting examples of suitable alkylaryl radicals are benzyl-[sic], ethylene- and propane-1,3-diyl-benzene.

Non-limiting examples of suitable cycloalkylaryl radicals are 2-, 3-, and 4-phenylcyclohex-1-yl.

Non-limiting examples of suitable arylalkyl radicals are 2-, 3- and 4-methyl-, -ethyl-, -propyl-, and -butylphen-1-yl.

Non-limiting examples of suitable arylcycloalkyl radicals are 2-, 3-, and 4-cyclohexylphen-1-yl.

The above-described radicals R¹ may be substituted. Electron-withdrawing or electron-donating atoms or organic radicals may be used for this purpose.

Examples of suitable substituents are halogen atoms, such as chlorine or fluorine, nitrile groups, nitro groups, partly or fully halogenated, such as chlorinated and/or fluorinated, alkyl, cycloalkyl, alkylcycloalkyl, cycloalkylalkyl, aryl, alkylaryl, cycloalkylaryl, arylalkyl and arylcycloalkyl radicals, including those exemplified above, especially tert-butyl; aryloxy, alkyloxy and cycloalkyloxy radicals, especially phenoxy, naphthoxy, methoxy, ethoxy, propoxy, butyloxy or cyclohexyloxy; arylthio, alkylthio and cycloalkylthio radicals, especially phenylthio, naphthylthio, methylthio, ethylthio, propylthio, butylthio or cyclohexylthio; hydroxyl groups; and/or primary, secondary and/or tertiary amino groups, especially amino, N-methylamino, N-ethylamino, N-propylamino, N-phenylamino, N-cyclohexylamino, N,N-dimethylamino, N,N-diethylamino, N,N-dipropylamino, N,N-diphenylamino, N,N-dicyclohexylamino, N-cyclohexyl-N-methylamino or N-ethyl-N-methylamino.

R¹ may comprise, consist essentially of, or consist of hydrogen. For example, R¹ may comprise hydrogen in at least 80% of the constitutional units according to formula I, such as at least 90% of the constitutional units, such as at least 92% of the constitutional units, such as at least 95% of the constitutional units, such as 100% of the constitutional units.

As used herein, the term “addition polymer” refers to a polymerization product at least partially comprising the residue of unsaturated monomers.

The hydroxyl-functional addition polymer may comprise constitutional units according to formula I in an amount of at least 70%, such as at least 80%, such as at least 85%, such as at least 90%, the % based upon the total constitutional units of the hydroxyl-functional addition polymer. The hydroxyl-functional addition polymer may comprise constitutional units according to formula I in an amount of no more than 100%, such as no more than 95%, such as no more than 92%, such as no more than 90%, the % based upon the total constitutional units of the hydroxyl-functional addition polymer. The hydroxyl-functional addition polymer may comprise constitutional units according to formula I in an amount of 70% to 95% of the hydroxyl-functional addition polymer, such as 80% to 95%, such as such as 85% to 95%, such as 90% to 95%, such as 92% to 95%, such as 70% to 92%, such as 80% to 92%, such as such as 85% to 92%, such as 90% to 92%, such as 70% to 90%, such as 80% to 90%, such as such as 85% to 90%, the % based upon the total constitutional units of the hydroxyl-functional addition polymer.

The hydroxyl-functional addition polymer may optionally further comprise constitutional units comprising the residue of a vinyl ester. The vinyl ester may comprise any suitable vinyl ester. For example, the vinyl ester may be according to the formula C(R¹)₂═C(R¹)(C(O)CH₃), wherein each R¹ is independently one of hydrogen, an alkyl group, a substituted alkyl group, a cycloalkyl group, a substituted cycloalkyl group, an alkylcycloalkyl group, a substituted alkylcycloalkyl group, a cycloalkylalkyl group, a substituted cycloalkylalkyl group, an aryl group, a substituted aryl group, an alkylaryl group, a substituted alkylaryl group, a cycloalkylaryl group, a substituted cycloalkylaryl group, an arylalkyl group, a substituted arylalkyl group, an arylcycloalkyl group, or a substituted arylcycloalkyl group. Non-limiting examples of suitable vinyl esters include vinyl acetate, vinyl formate, or any combination thereof.

The hydroxyl-functional addition polymer may be formed from polymerizing vinyl ester monomers to form an intermediate polymer comprising constitutional units comprising the residue of vinyl ester, and then hydrolyzing the constitutional units comprising the residue of vinyl ester of the intermediate polymer to form the hydroxyl-functional addition polymer. The residue of vinyl ester may comprise 70% of the constitutional units comprising the intermediate polymer, such as at least 80%, such as at least 85%, such as at least 90%, the % based upon the total constitutional units of the intermediate polymer. The residue of vinyl ester may comprise no more than 100% of the constitutional units comprising the intermediate polymer, such as no more than 95%, such as no more than 92%, such as no more than 90%, the % based upon the total constitutional units of the intermediate polymer. The residue of vinyl ester may comprise 70% to 95% of the hydroxyl-functional addition polymer, such as 80% to 95%, such as such as 85% to 95%, such as 90% to 95%, such as 92% to 95%, such as 70% to 92%, such as 80% to 92%, such as such as 85% to 92%, such as 90% to 92%, such as 70% to 90%, such as 80% to 90%, such as such as 85% to 90%, the % based upon the total constitutional units of the intermediate polymer.

The hydroxyl-functional addition polymer may have a theoretical hydroxyl equivalent weight of at least 30 g/hydroxyl group (“OH”), such as at least 35 g/OH, such as at least 40 g/OH, such as at least 44 g/OH. The hydroxyl-functional addition polymer may have a theoretical hydroxyl equivalent weight of no more than 200 g/OH, such as no more than 100 g/OH, such as no more than 60 g/OH, such as no more than 50 g/OH. The hydroxyl-functional addition polymer may have a theoretical hydroxyl equivalent weight of 30 g/OH to 200 g/OH, such as 30 g/OH to 100 g/OH, such as 30 g/OH to 60 g/OH, such as 30 g/OH to 50 g/OH, such as 35 g/OH to 200 g/OH, such as 35 g/OH to 100 g/OH, such as 35 g/OH to 60 g/OH, such as 35 g/OH to 50 g/OH, such as 40 g/OH to 200 g/OH, such as 40 g/OH to 100 g/OH, such as 40 g/OH to 60 g/OH, such as 40 g/OH to 50 g/OH, such as 44 g/OH to 200 g/OH, such as 44 g/OH to 100 g/OH, such as 44 g/OH to 60 g/OH, such as 44 g/OH to 50 g/OH. As used herein, the term “theoretical hydroxyl equivalent weight” refers to the weight in grams of hydroxyl-functional addition polymer resin solids divided by the theoretical equivalents of hydroxyl groups present in the hydroxyl-functional addition polymer, and may be calculated according to the following formula (a):

$$( a ) hydroxyl equivalent weight = \frac{total grams addition polymer resin solds}{theoretical equivalents of OH}$$

The hydroxyl-functional addition polymer may have a theoretical hydroxyl value of at least 1,000 mg KOH/gram addition polymer, such as at least 1,100 mg KOH/gram addition polymer, such as at least 1,150 mg KOH/gram addition polymer, such as at least 1,200 mg KOH/gram addition polymer. The hydroxyl-functional addition polymer may have a theoretical hydroxyl value of no more than 1,300 mg KOH/gram addition polymer, such as no more than 1,200 mg KOH/gram addition polymer, such as no more than 1,150 mg KOH/gram addition polymer. The hydroxyl-functional addition polymer may have a theoretical hydroxyl value of 1,000 to 1,300 mg KOH/gram addition polymer, such as 1,000 to 1,200 mg KOH/gram addition polymer, such as 1,000 to 1,150 mg KOH/gram addition polymer, such as 1,100 to 1,300 mg KOH/gram addition polymer, such as 1,100 to 1,200 mg KOH/gram addition polymer, such as 1,100 to 1,150 mg KOH/gram addition polymer, such as 1,150 to 1,300 mg KOH/gram addition polymer, such as 1,150 to 1,200 mg KOH/gram addition polymer. As used herein, the term “theoretical hydroxyl value” typically refers to the number of milligrams of potassium hydroxide required to neutralize the acetic acid taken up on acetylation of one gram of a chemical substance that contains free hydroxyl groups and was herein determined by a theoretical calculation of the number of free hydroxyl groups theoretically present in one gram of the hydroxyl-functional addition polymer.

The hydroxyl-functional addition polymer may have a number average molecular weight (Mₙ) of at least 5,000 g/mol, such as at least 20,000 g/mol, such as at least 25,000 g/mol, such as at least 50,000 g/mol, such as at least 75,000 g/mol, such as 100,000 g/mol, such as 125,000 g/mol, as determined by Gel Permeation Chromatography using polystyrene calibration standards. The hydroxyl-functional addition polymer may have a number average molecular weight (Mₙ) of no more than 500,000 g/mol, such as no more than 300,000 g/mol, such as no more than 200,000, such as no more than 125,000 g/mol, such as no more than 100,000 g/mol, as determined by Gel Permeation Chromatography using polystyrene calibration standards. The hydroxyl-functional addition polymer may have a number average molecular weight (Mₙ) of 5,000 g/mol to 500,000 g/mol, such as 5,000 g/mol to 300,000 g/mol, such as 5,000 g/mol to 200,000 g/mol, such as 5,000 g/mol to 125,000 g/mol, such as 5,000 g/mol to 100,000 g/mol, such as 20,000 g/mol to 500,000 g/mol, such as 20,000 g/mol to 300,000 g/mol, such as 20,000 g/mol to 200,000 g/mol, such as 20,000 g/mol to 125,000 g/mol, such as 20,000 g/mol to 100,000 g/mol, such as 25,000 g/mol to 500,000 g/mol, such as 25,000 g/mol to 300,000 g/mol, such as 25,000 to 200,000 g/mol, such as 25,000 g/mol to 125,000 g/mol, such as 25,000 g/mol to 100,000 g/mol, such as 50,000 g/mol to 500,000 g/mol, such as 50,000 g/mol to 300,000 g/mol, such as 50,000 g/mol to 200,000 g/mol, such as 50,000 g/mol to 125,000 g/mol, such as 50,000 g/mol to 100,000 g/mol, such as 75,000 g/mol to 500,000 g/mol, such as 75,000 g/mol to 300,000 g/mol, such as 75,000 g/mol to 200,000 g/mol, such as 75,000 g/mol to 125,000 g/mol, such as 100,000 g/mol to 500,000 g/mol, such as 100,000 g/mol to 300,000 g/mol, such as 100,000 g/mol to 200,000 g/mol, such as 100,000 g/mol to 125,000 g/mol, as determined by Gel Permeation Chromatography using polystyrene calibration standards.

The hydroxyl-functional addition polymer may have a weight average molecular weight (M_{w}) of at least 5,000 g/mol, such as at least 20,000 g/mol, such as at least 25,000 g/mol, such as at least 50,000 g/mol, such as at least 75,000 g/mol, such as 100,000 g/mol, such as 125,000 g/mol, such as at least 150,000 g/mol, such as at least 200,000 g/mol, such as at least 250,000 g/mol, such as at least 300,000 g/mol, as determined by Gel Permeation Chromatography using polystyrene calibration standards. The hydroxyl-functional addition polymer may have a weight average molecular weight (M_{w}) of no more than 500,000 g/mol, such as no more than 300,000 g/mol, such as no more than 200,000, such as no more than 125,000 g/mol, such as no more than 100,000 g/mol, as determined by Gel Permeation Chromatography using polystyrene calibration standards. The hydroxyl-functional addition polymer may have a weight average molecular weight of 5,000 g/mol to 500,000 g/mol, such as 5,000 g/mol to 300,000 g/mol, such as 5,000 g/mol to 200,000 g/mol, such as 5,000 g/mol to 125,000 g/mol, such as 5,000 g/mol to 100,000 g/mol, such as 20,000 g/mol to 500,000 g/mol, such as 20,000 g/mol to 300,000 g/mol, such as 20,000 g/mol to 200,000 g/mol, such as 20,000 g/mol to 125,000 g/mol, such as 20,000 g/mol to 100,000 g/mol, such as 25,000 g/mol to 500,000 g/mol, such as 25,000 g/mol to 300,000 g/mol, such as 25,000 to 200,000 g/mol, such as 25,000 g/mol to 125,000 g/mol, such as 25,000 g/mol to 100,000 g/mol, such as 50,000 g/mol to 500,000 g/mol, such as 50,000 g/mol to 300,000 g/mol, such as 50,000 g/mol to 200,000 g/mol, such as 50,000 g/mol to 125,000 g/mol, such as 50,000 g/mol to 100,000 g/mol, such as 75,000 g/mol to 500,000 g/mol, such as 75,000 g/mol to 300,000 g/mol, such as 75,000 g/mol to 200,000 g/mol, such as 75,000 g/mol to 125,000 g/mol, such as 100,000 g/mol to 500,000 g/mol, such as 100,000 g/mol to 300,000 g/mol, such as 100,000 g/mol to 200,000 g/mol, such as 100,000 g/mol to 125,000 g/mol, such as 125,000 g/mol to 500,000 g/mol, such as 125,000 g/mol to 300,000 g/mol, such as 125,000 g/mol to 200,000 g/mol, such as 150,000 g/mol to 500,000 g/mol, such as 150,000 g/mol to 300,000 g/mol, such as 150,000 g/mol to 200,000 g/mol, such as 200,000 g/mol to 500,000 g/mol, such as 200,000 g/mol to 300,000 g/mol, such as 250,000 g/mol to 500,000 g/mol, such as 250,000 g/mol to 300,000 g/mol, such as 300,000 g/mol to 500,000 g/mol, as determined by Gel Permeation Chromatography using polystyrene calibration standards.

As used herein, unless otherwise stated, the terms “number average molecular weight (Mₙ)” and “weight average molecular weight (M_{w})” means the number average molecular weight (M_{z}) and the weight average molecular weight (M_{w}) as determined by Gel Permeation Chromatography using Waters 2695 separation module with a Waters 410 differential refractometer (RI detector), polystyrene standards having molecular weights of from approximately 500 g/mol to 900,000 g/mol, dimethylformamide (DMF) with 0.05 M lithium bromide (LiBr) as the eluent at a flow rate of 0.5 mL/min, and one Asahipak GF-510 HQ column for separation.

The hydroxyl-functional addition polymer may have a z-average molecular weight (M_{z}) of at least 10,000 g/mol, such as at least 15,000 g/mol, such as at least 20,000 g/mol, as determined by Gel Permeation Chromatography using polystyrene calibration standards. The hydroxyl-functional addition polymer may have a z-average molecular weight (M_{z}) of no more than 35,000 g/mol, such as no more than 25,000 g/mol, such as no more than 20,000 g/mol, as determined by Gel Permeation Chromatography using polystyrene calibration standards. The hydroxyl-functional addition polymer may have a z-average molecular weight (M_{z}) of 10,000 g/mol to 35,000 g/mol, such as 10,000 g/mol to 25,000 g/mol, such as 10,000 g/mol to 20,000 g/mol, such as 15,000 g/mol to 35,000 g/mol, such as 15,000 g/mol to 25,000 g/mol, such as 15,000 g/mol to 20,000 g/mol, such as 20,000 to 35,000 g/mol, such as 20,000 g/mol to 25,000 g/mol, as determined by Gel Permeation Chromatography using polystyrene calibration standards.

As used herein, unless otherwise stated, the terms “z-average molecular weight (M_{z})” means the z-average molecular weight (M_{z}) and the z-average molecular weight (M_{z}) as determined by Gel Permeation Chromatography using Waters 2695 separation module with a Waters 410 differential refractometer (RI detector), polystyrene standards having molecular weights of from approximately 500 g/mol to 900,000 g/mol, dimethylformamide (DMF) with 0.05 M lithium bromide (LiBr) as the eluent at a flow rate of 0.5 mL/min, and one Asahipak GF-510 HQ column for separation.

According to the present disclosure, a 4% by weight solution of the hydroxyl-functional addition polymer dissolved in water may have a viscosity of at least 10 cP as measured using a Brookfield synchronized-motor rotary type viscometer at 20° C., such as at least 15 cP, such as at least 20 cP. A 4% by weight solution of the hydroxyl-functional addition polymer dissolved in water may have a viscosity of no more than 110 cP as measured using a Brookfield synchronized-motor rotary type viscometer at 20° C., such as no more than 90 cP, such as no more than 70 cP, such as no more than 60 cP, such as no more than 50 cP, such as no more than 40 cP. A 4% by weight solution of the hydroxyl-functional addition polymer dissolved in water may have a viscosity of 10 to 110 cP as measured using a Brookfield synchronized-motor rotary type viscometer at 20° C., such as 10 to 90 cP, such as 10 to 70 cP, such as 10 to 50 cP, such as 10 to 40 cP, such as 15 to 110 cP, such as 15 to 90 cP, such as 15 to 70 cP, such as 15 to 60 cP, such as 15 to 50 cP, such as 15 to 40 cP, such as 20 to 110 cP, such as 20 to 90 cP, such as 20 to 70 cP, such as 20 to 60 cP, such as 20 to 50 cP, such as 20 to 40 cP.

The hydroxyl-functional addition polymer described above may be present in the electrodepositable coating composition in an amount of at least 0.01% by weight, such as at least 0.1% by weight, such as at least 0.3% by weight, such as at least 0.5% by weight, such as at least 0.75% by weight, such as 1% by weight, based on the total weight of the resin solids of the electrodepositable coating composition. The hydroxyl-functional addition polymer described above may be present in the electrodepositable coating composition in an amount no more than 5% by weight, such as no more than 3% by weight, such as no more than 2% by weight, such as no more than 1.5% by weight, such as no more than 1% by weight, such as n no more than 0.75% by weight, based on the total weight of the resin solids of the electrodepositable coating composition. The hydroxyl-functional addition polymer may be present in the electrodepositable coating composition in an amount of 0.01% to 5% by weight, such as 0.01% to 3% by weight, such as 0.01% to 2% by weight, such as 0.01% to 1.5% by weight, such as 0.01% to 1% by weight, such as 0.01% to 0.75% by weight, such as 0.1% to 5% by weight, such as 0.1% to 3% by weight, such as 0.1% to 2% by weight, such as 0.1% to 1.5% by weight, such as 0.1% to 1% by weight, such as 0.1% to 0.75% by weight, such as 0.3% to 5% by weight, such as 0.3% to 3% by weight, such as 0.3% to 2% by weight, such as 0.3% to 1.5% by weight, such as 0.3% to 1% by weight, such as 0.3% to 0.75% by weight, such as 0.5% to 5% by weight, such as 0.5% to 3% by weight, such as 0.5% to 2% by weight, such as 0.5% to 1.5% by weight, such as 0.5% to 1% by weight, such as 0.5% to 0.75% by weight, such as 1% to 5% by weight, such as 1% to 3% by weight, such as 1% to 2% by weight, such as 1% to 1.5% by weight, based on the total weight of the resin solids of the electrodepositable coating composition.

### Ionic Salt Group-Containing Film-Forming Polymer

The electrodepositable coating composition comprises an ionic salt group-containing film-forming polymer. The ionic salt group-containing film-forming polymer is capable of being applied onto a substrate by electrodeposition. The ionic salt group-containing film-forming polymer may comprise a cationic salt group-containing film-forming polymer or an anionic salt group-containing film-forming polymer.

The ionic salt group-containing film-forming polymer may optionally comprise a reaction product of a reaction mixture comprising (a) a polyepoxide; (b) di-functional chain extender; and (c) a mono-functional reactant.

The polyepoxide may comprise any suitable polyepoxide. For example, the polyepoxide may comprise a di-epoxide. Non-limiting examples of suitable polyepoxide include diglycidyl ethers of bisphenols, such as a diglycidyl ether of bisphenol A or bisphenol F.

The di-functional chain extender may comprise any suitable di-functional chain extender. For example, the di-functional chain extender may comprise a di-hydroxyl functional reactant, a di-carboxylic acid functional reactant, or a primary amine functional reactant. The di-hydroxyl functional reactant may comprise, for example, a bisphenol such as bisphenol A and/or bisphenol F. The di-carboxylic acid functional reactant may comprise, for example, a dimer fatty acid.

The mono-functional reactant may comprise a monophenol, a mono-functional acid, dimethylethanolamine, a monoepoxide such as the glycidyl ether of phenol, the glycidyl ether of nonylphenol, or the glycidyl ether of cresol, or any combination thereof.

The monophenol may comprise any suitable monophenol. For example, the monophenol may comprise phenol, 2-hydroxytoluene, 3-hydroxytoluene, 4-hydroxytoluene, 2-tert-butylphenol, 4-tert-butylphenol, 2-tert-butyl-4-methylphenol, 2-methoxyphenol, 4-methoxyphenol, 2-hydroxybenzyl alcohol, 4-hydroxybenzyl alcohol, nonylphenol, dodecylphenol, 1-hydroxynaphthalene, 2-hydroxynaphthalene, biphenyl-2-ol, biphenyl-4-ol and 2-allylphenol.

The mono-functional acid may comprise any compound or mixture of compounds having one carboxyl group per molecule. In addition to the carboxyl group, the mono-functional acid may comprise other functional groups that are not chemically reactive with epoxide, hydroxyl or carboxyl functional groups, and, therefore, do not interfere with the polymerization reaction. The mono-functional acid may comprise aromatic monoacids such as benzoic acid or phenylalkanoic acids such as phenylacetic acid, 3-phenylpropanoic acid, and the like, and aliphatic mono-acids, as well as combinations thereof.

The ratio of functional groups from the di-functional chain extender and mono-functional reactant to the epoxide functional groups from the polyepoxide may be at least 0.50:1, such as at least 0.60:1, such as at least 0.65:1, such as at least 0.70:1. The ratio of functional groups from the di-functional chain extender and mono-functional reactant to the epoxide functional groups from the polyepoxide may be no more than 0.85:1, such as no more than such as no more than 0.80:1, such as no more than 0.75:1, such as no more than 0.70:1. The ratio of functional groups from the di-functional chain extender and mono-functional reactant to the epoxide functional groups from the polyepoxide may be 0.50:1 to 0.85:1, such as 0.50:1 to 0.80:1, such as 0.50:1 to 0.75:1, such as 0.50:1 to 0.70:1, such as 0.60:1 to 0.85:1, such as 0.60:1 to 0.80:1, such as 0.60:1 to 0.75:1, such as 0.60:1 to 0.70:1, such as 0.65:1 to 0.85:1, such as 0.65:1 to 0.80:1, such as 0.65:1 to 0.75:1, such as 0.65:1 to 0.70:1, such as 0.70:1 to 0.85:1, such as 0.70:1 to 0.80:1, such as 0.70:1 to 0.75:1.

The di-functional chain extender may comprise a di-hydroxyl functional reactant such as a bisphenol. The ratio of total phenolic hydroxyl groups from the bisphenol di-functional chain extender and functional groups from the mono-functional reactant to epoxide functional groups from the polyepoxide may be at least 0.50:1, such as at least 0.60:1, such as at least 0.65:1, such as at least 0.70:1. The ratio of total phenolic hydroxyl groups from the bisphenol di-functional chain extender and functional groups from the mono-functional reactant to epoxide functional groups from the polyepoxide may be no more than 0.85:1, such as no more than such as no more than 0.80:1, such as no more than 0.75:1, such as no more than 0.70:1. The ratio of total phenolic hydroxyl groups from the bisphenol di-functional chain extender and functional groups from the mono-functional reactant to epoxide functional groups from the polyepoxide may be 0.50:1 to 0.85:1, such as 0.50:1 to 0.80:1, such as 0.50:1 to 0.75:1, such as 0.50:1 to 0.70:1, such as 0.60:1 to 0.85:1, such as 0.60:1 to 0.80:1, such as 0.60:1 to 0.75:1, such as 0.60:1 to 0.70:1, such as 0.65:1 to 0.85:1, such as 0.65:1 to 0.80:1, such as 0.65:1 to 0.75:1, such as 0.65:1 to 0.70:1, such as 0.70:1 to 0.85:1, such as 0.70:1 to 0.80:1, such as 0.70:1 to 0.75:1.

The di-functional chain extender may comprise a di-hydroxyl functional reactant such as a bisphenol. The ratio of total phenolic hydroxyl groups from the bisphenol di-functional chain extender and acid groups from the mono-functional acid to epoxide functional groups from the polyepoxide may be at least 0.50:1, such as at least 0.60:1, such as at least 0.65:1, such as at least 0.70:1. The ratio of total phenolic hydroxyl groups from the bisphenol di-functional chain extender and acid groups from the mono-functional acid to epoxide functional groups from the polyepoxide may be no more than 0.85:1, such as no more than such as no more than 0.80:1, such as no more than 0.75:1, such as no more than 0.70:1. The ratio of total phenolic hydroxyl groups from the bisphenol di-functional chain extender and acid groups from the mono-functional acid to epoxide functional groups from the polyepoxide may be 0.50:1 to 0.85:1, such as 0.50:1 to 0.80:1, such as 0.50:1 to 0.75:1, such as 0.50:1 to 0.70:1, such as 0.60:1 to 0.85:1, such as 0.60:1 to 0.80:1, such as 0.60:1 to 0.75:1, such as 0.60:1 to 0.70:1, such as 0.65:1 to 0.85:1, such as 0.65:1 to 0.80:1, such as 0.65:1 to 0.75:1, such as 0.65:1 to 0.70:1, such as 0.70:1 to 0.85:1, such as 0.70:1 to 0.80:1, such as 0.70:1 to 0.75:1.

The di-functional chain extender may comprise a di-hydroxyl functional reactant such as a bisphenol. The ratio of total phenolic hydroxyl groups from the bisphenol di-functional chain extender and phenolic hydroxyl groups from the monophenol to epoxide functional groups from the polyepoxide may be at least 0.50:1, such as at least 0.60:1, such as at least 0.65:1, such as at least 0.70:1. The ratio of total phenolic hydroxyl groups from the bisphenol di-functional chain extender and phenolic hydroxyl groups from the monophenol to epoxide functional groups from the polyepoxide may be no more than 0.85:1, such as no more than such as no more than 0.80:1, such as no more than 0.75:1, such as no more than 0.70:1. The ratio of total phenolic hydroxyl groups from the bisphenol di-functional chain extender and phenolic hydroxyl groups from the monophenol to epoxide functional groups from the polyepoxide may be 0.50:1 to 0.85:1, such as 0.50:1 to 0.80:1, such as 0.50:1 to 0.75:1, such as 0.50:1 to 0.70:1, such as 0.60:1 to 0.85:1, such as 0.60:1 to 0.80:1, such as 0.60:1 to 0.75:1, such as 0.60:1 to 0.70:1, such as 0.65:1 to 0.85:1, such as 0.65:1 to 0.80:1, such as 0.65:1 to 0.75:1, such as 0.65:1 to 0.70:1, such as 0.70:1 to 0.85:1, such as 0.70:1 to 0.80:1, such as 0.70:1 to 0.75:1.

The di-functional chain extender may comprise a di-hydroxyl functional reactant such as a bisphenol. The ratio of phenolic hydroxyl functional groups from the bisphenol di-functional chain extender to phenolic hydroxyl functional groups from the monophenol and/or acid groups from the mono-functional acid may be at least 0.05:1, such as at least 0.1:1, such as at least 0.2:1, such as at least 0.3:1, such as at least 0.4:1, such as at least 0.5:1, such as at least 0.6:1, such as at least 0.7:1, such as at least 0.8:1. The ratio of phenolic hydroxyl functional groups from the bisphenol di-functional chain extender to phenolic hydroxyl functional groups from the monophenol may be no more than 9:1, such as no more than 4:1, such as no more than 2:1, such as no more than 1:1, such as no more than 0.8:1. The ratio of phenolic hydroxyl functional groups from the bisphenol di-functional chain extender to phenolic hydroxyl functional groups from the monophenol may be 0.05:1 to 9:1, such as 0.05:1 to 4:1, such as 0.05:1 to 2:1, such as 0.05:1 to 1:1, such as 0.05:1 to 0.8:1, such as 0.1:1 to 9:1, such as 0.1:1 to 4:1, such as 0.1:1 to 2:1, such as 0.1:1 to 1:1, such as 0.1:1 to 0.8:1, such as 0.2:1 to 9:1, such as 0.2:1 to 4:1, such as 0.2:1 to 2:1, such as 0.2:1 to 1:1, such as 0.2:1 to 0.8:1, such as 0.3:1 to 9:1, such as 0.3:1 to 4:1, such as 0.3:1 to 2:1, such as 0.3:1 to 1:1, such as 0.3:1 to 0.8:1, such as 0.4:1 to 9:1, such as 0.4:1 to 4:1, such as 0.4:1 to 2:1, such as 0.4:1 to 1:1, such as 0.4:1 to 0.8:1, such as 0.5:1 to 9:1, such as 0.5:1 to 4:1, such as 0.5:1 to 2:1, such as 0.5:1 to 1:1, such as 0.5:1 to 0.8:1, such as 0.6:1 to 9:1, such as 0.6:1 to 4:1, such as 0.6:1 to 2:1, such as 0.6:1 to 1:1, such as 0.6:1 to 0.8:1, such as 0.7:1 to 9:1, such as 0.7:1 to 4:1, such as 0.7:1 to 2:1, such as 0.7:1 to 1:1, such as 0.7:1 to 0.8:1, such as 0.8:1 to 9:1, such as 0.8:1 to 4:1, such as 0.8:1 to 2:1, such as 0.8:1 to 1:1.

The reaction product of a reaction mixture comprising (a) a polyepoxide; (b) di-functional chain extender; and (c) a mono-functional reactant may have an epoxy equivalent weight of at least 700 g/equivalent, such as at least 800 g/equivalent, such as at least 850 g/equivalent. The reaction product of a reaction mixture comprising (a) a polyepoxide; (b) di-functional chain extender; and (c) a mono-functional reactant may have an epoxy equivalent weight of no more than 1,500 g/equivalent, such as no more than 1,400 g/equivalent, such as no more than 1,200 g/equivalent, such as no more than 1,100 g/equivalent. The reaction product of a reaction mixture comprising (a) a polyepoxide; (b) di-functional chain extender; and (c) a mono-functional reactant may have an epoxy equivalent weight of 700 to 1,500 g/equivalent, such as 700 to 1,400 g/equivalent, such as 700 to 1,200 g/equivalent, such as 700 to 1,100 g/equivalent, such as 800 to 1,500 g/equivalent, such as 800 to 1,400 g/equivalent, such as 800 to 1,200 g/equivalent, such as 800 to 1,100 g/equivalent, such as 850 to 1,500 g/equivalent, such as 850 to 1,400 g/equivalent, such as 850 to 1,200 g/equivalent, such as 850 to 1,100 g/equivalent.

Cationic salt groups may be incorporated into the reaction product of a reaction mixture comprising (a) a polyepoxide; (b) di-functional chain extender; and (c) a mono-functional reactant as follows: The reaction product may be reacted with a cationic salt group former. By “cationic salt group former” is meant a material which is reactive with epoxy groups present and which may be acidified before, during, or after reaction with the epoxy groups on the reaction product to form cationic salt groups. Examples of suitable materials include amines such as primary or secondary amines which can be acidified after reaction with the epoxy groups to form amine salt groups, or tertiary amines which can be acidified prior to reaction with the epoxy groups and which after reaction with the epoxy groups form quaternary ammonium salt groups. Examples of other cationic salt group formers are sulfides which can be mixed with acid prior to reaction with the epoxy groups and form ternary sulfonium salt groups upon subsequent reaction with the epoxy groups.

Anionic salt groups may be incorporated into the reaction product of a reaction mixture comprising (a) a polyepoxide; (b) di-functional chain extender; and (c) a mono-functional reactant by reacting the reaction product with a polyprotic acid. Suitable polyprotic acids include, for example, an oxyacid of phosphorus, such as phosphoric acid and/or phosphonic acid.

The ionic salt group-containing film-forming polymer may comprise a cationic salt group containing film-forming polymer. The cationic salt group-containing film-forming polymer may be used in a cationic electrodepositable coating composition. As used herein, the term “cationic salt group-containing film-forming polymer” refers to polymers that include at least partially neutralized cationic groups, such as sulfonium groups and ammonium groups, that impart a positive charge. The cationic salt group-containing film-forming polymer may comprise active hydrogen functional groups. The term “active hydrogen” refers to hydrogens which, because of their position in the molecule, display activity according to the Zerewitinoff test, as described in the JOURNAL OF THE AMERICAN CHEMICAL SOCIETY, Vol. 49, page 3181 (1927). Accordingly, active hydrogens include hydrogen atoms attached to oxygen, nitrogen, or sulfur, and thus active hydrogen functional groups include, for example, hydroxyl, thiol, primary amino, and/or secondary amino groups (in any combination). Cationic salt group-containing film-forming polymers that comprise active hydrogen functional groups may be referred to as active hydrogen-containing, cationic salt group-containing film-forming polymers.

Examples of polymers that are suitable for use as the cationic salt group-containing film-forming polymer in the present disclosure include, but are not limited to, alkyd polymers, acrylics, polyepoxides, polyamides, polyurethanes, polyureas, polyethers, and polyesters, among others.

More specific examples of suitable active hydrogen-containing, cationic salt group containing film-forming polymers include polyepoxide-amine adducts, such as the adduct of a polyglycidyl ethers of a polyphenol, such as Bisphenol A, and primary and/or secondary amines, such as are described in U.S. Pat. No. 4,031,050 at col. 3, line 27 to col. 5, line 50, U.S. Pat. No. 4,452,963 at col. 5, line 58 to col. 6, line 66, and U.S. Pat. No. 6,017,432 at col. 2, line 66 to col. 6, line 26, these portions of which being incorporated herein by reference. A portion of the amine that is reacted with the polyepoxide may be a ketimine of a polyamine, as is described in U.S. Pat. No. 4,104,147 at col. 6, line 23 to col. 7, line 23, the cited portion of which being incorporated herein by reference. Also suitable are ungelled polyepoxide-polyoxyalkylenepolyamine resins, such as are described in U.S. Pat. No. 4,432,850 at col. 2, line 60 to col. 5, line 58, the cited portion of which being incorporated herein by reference. In addition, cationic acrylic resins, such as those described in U.S. Pat. No. 3,455,806 at col. 2, line 18 to col. 3, line 61 and 3,928,157 at col. 2, line 29 to col. 3, line 21, these portions of both of which are incorporated herein by reference, may be used.

Besides amine salt group-containing resins, quaternary ammonium salt group-containing resins may also be employed as a cationic salt group-containing film-forming polymer in the present disclosure. Examples of these resins are those which are formed from reacting an organic polyepoxide with a tertiary amine acid salt. Such resins are described in U.S. Pat. No. 3,962,165 at col. 2, line 3 to col. 11, line 7; U.S. Pat. No. 3,975,346 at col. 1, line 62 to col. 17, line 25 and U.S. Pat. No. 4,001,156 at col. 1, line 37 to col. 16, line 7, these portions of which being incorporated herein by reference. Examples of other suitable cationic resins include ternary sulfonium salt group-containing resins, such as those described in U.S. Pat. No. 3,793,278 at col. 1, line 32 to col. 5, line 20, this portion of which being incorporated herein by reference. Also, cationic resins which cure via a transesterification mechanism, such as described in European Patent Application No. 12463B1 at pg. 2, line 1 to pg. 6, line 25, this portion of which being incorporated herein by reference, may be employed.

Other suitable cationic salt group-containing film-forming polymers include those that may form photodegradation resistant electrodepositable coating compositions. Such polymers include the polymers comprising cationic amine salt groups which are derived from pendant and/or terminal amino groups that are disclosed in U.S. Patent Application Publication No. 2003/0054193 A1 at paragraphs [0064] to [0088], this portion of which being incorporated herein by reference. Also suitable are the active hydrogen-containing, cationic salt group-containing resins derived from a polyglycidyl ether of a polyhydric phenol that is essentially free of aliphatic carbon atoms to which are bonded more than one aromatic group, which are described in U.S. Patent Application Publication No. 2003/0054193 A1 at paragraphs [0096] to [0123], this portion of which being incorporated herein by reference.

The active hydrogen-containing, cationic salt group-containing film-forming polymer is made cationic and water dispersible by at least partial neutralization with an acid. Suitable acids include organic and inorganic acids. Non-limiting examples of suitable organic acids include formic acid, acetic acid, methanesulfonic acid, and lactic acid. Non-limiting examples of suitable inorganic acids include phosphoric acid and sulfamic acid. By “sulfamic acid” is meant sulfamic acid itself or derivatives thereof such as those having the formula:

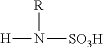

wherein R is hydrogen or an alkyl group having 1 to 4 carbon atoms. Mixtures of the above-mentioned acids also may be used in the present disclosure.

The extent of neutralization of the cationic salt group-containing film-forming polymer may vary with the particular polymer involved. However, sufficient acid should be used to sufficiently neutralize the cationic salt-group containing film-forming polymer such that the cationic salt-group containing film-forming polymer may be dispersed in an aqueous dispersing medium at room temperature in the amounts described herein. For example, the amount of acid used may provide at least 20% of all of the total theoretical neutralization. Excess acid may also be used beyond the amount required for 100% total theoretical neutralization. For example, the amount of acid used to neutralize the cationic salt group-containing film-forming polymer may be ≥0.1% based on the total amines in the active hydrogen-containing, cationic salt group-containing film-forming polymer. Alternatively, the amount of acid used to neutralize the active hydrogen-containing, cationic salt group-containing film-forming polymer may be 100% based on the total amines in the active hydrogen-containing, cationic salt group-containing film-forming polymer. The total amount of acid used to neutralize the cationic salt group-containing film-forming polymer may range between any combination of values, which were recited in the preceding sentences, inclusive of the recited values. For example, the total amount of acid used to neutralize the active hydrogen-containing, cationic salt group-containing film-forming polymer may be equal to or greater than 20%, 35%, 50%, 60%, or 80% based on the total amines in the cationic salt group-containing film-forming polymer.

The cationic salt group-containing film-forming polymer may be present in the cationic electrodepositable coating composition in an amount of at least 40% by weight, such as at least 50% by weight, such as at least 60% by weight, and may be present in the in an amount of no more than 90% by weight, such as no more than 80% by weight, such as no more than 75% by weight, based on the total weight of the resin solids of the electrodepositable coating composition. The cationic salt group-containing film-forming polymer may be present in the cationic electrodepositable coating composition in an amount of 40% to 90% by weight, such as 50% to 80% by weight, such as 60% to 75% by weight, based on the total weight of the resin solids of the electrodepositable coating composition.

Alternatively, the ionic salt group containing film-forming polymer may comprise an anionic salt group-containing film-forming polymer. As used herein, the term “anionic salt group-containing film-forming polymer” refers to an anionic polymer comprising at least partially neutralized anionic functional groups, such as carboxylic acid and phosphoric acid groups, that impart a negative charge to the polymer. The anionic salt group-containing film-forming polymer may comprise active hydrogen functional groups. Anionic salt group-containing film-forming polymers that comprise active hydrogen functional groups may be referred to as active hydrogen-containing, anionic salt group-containing film-forming polymers. The anionic salt group containing film-forming polymer may be used in an anionic electrodepositable coating composition.

The anionic salt group-containing film-forming polymer may comprise base-solubilized, carboxylic acid group-containing film-forming polymers such as the reaction product or adduct of a drying oil or semi-drying fatty acid ester with a dicarboxylic acid or anhydride; and the reaction product of a fatty acid ester, unsaturated acid or anhydride and any additional unsaturated modifying materials which are further reacted with polyol. Also suitable are the at least partially neutralized interpolymers of hydroxy-alkyl esters of unsaturated carboxylic acids, unsaturated carboxylic acid and at least one other ethylenically unsaturated monomer. Still another suitable anionic electrodepositable resin comprises an alkyd-aminoplast vehicle, i.e., a vehicle containing an alkyd resin and an amine-aldehyde resin. Another suitable anionic electrodepositable resin composition comprises mixed esters of a resinous polyol. Other acid functional polymers may also be used such as phosphatized polyepoxide or phosphatized acrylic polymers. Exemplary phosphatized polyepoxides are disclosed in U.S. Patent Application Publication No. 2009-0045071 at [0004]-[0015] and U.S. patent application Ser. No. 13/232,093 at [0014]-[0040], the cited portions of which being incorporated herein by reference. Also suitable are resins comprising one or more pendent carbamate functional groups, such as those described in U.S. Pat. No. 6,165,338.

The anionic salt group-containing film-forming polymer may be present in the anionic electrodepositable coating composition in an amount of at least 50% by weight, such as at least 55% by weight, such as at least 60% by weight, and may be present in an amount of no more than 90% by weight, such as no more than 80% by weight, such as no more than 75% by weight, based on the total weight of the resin solids of the electrodepositable coating composition. The anionic salt group-containing film-forming polymer may be present in the anionic electrodepositable coating composition in an amount 50% to 90%, such as 55% to 80%, such as 60% to 75%, based on the total weight of the resin solids of the electrodepositable coating composition.

The ionic salt group-containing film-forming polymer may be present in the electrodepositable coating composition in an amount of at least 40% by weight, such as at least 50% by weight, such as at least 55% by weight, such as at least 60% by weight, based on the total weight of the resin solids of the electrodepositable coating composition. The ionic salt group-containing film-forming polymer may be present in the electrodepositable coating composition in an amount of no more than 90% by weight, such as no more than 80% by weight, such as no more than 75% by weight, based on the total weight of the resin solids of the electrodepositable coating composition. The ionic salt group-containing film-forming polymer may be present in the electrodepositable coating composition in an amount of 40% to 90% by weight, such as 50% to 90% by weight, such as 50% to 80% by weight, such as 55% to 80% by weight, such as 60% to 75% by weight, based on the total weight of the resin solids of the electrodepositable coating composition.

### Blocked Polyisocyanate Curing Agent

According to the present disclosure, the electrodepositable coating composition of the present disclosure further comprises a blocked polyisocyanate curing agent.

As used herein, a “blocked polyisocyanate” means a polyisocyanate wherein at least a portion of the isocyanato groups is blocked by a blocking group introduced by the reaction of a free isocyanato group of the polyisocyanate with a blocking agent. By “blocked” is meant that the isocyanato groups have been reacted with a blocking agent such that the resultant blocked isocyanate group is stable to active hydrogens at ambient temperature, e.g., room temperature (about 23° C.), but reactive with active hydrogens in the film-forming polymer at elevated temperatures, such as, for example, between 90° C. and 200° C. Therefore, a blocked polyisocyanate curing agent comprises a polyisocyanate reacted with one or more blocking agent(s). As used herein, a “blocking agent” refers to a compound comprising a functional group reactive with an isocyanato group present on the polyisocyanate resulting in binding a residual moiety of the blocking agent to the isocyanato group so that the isocyanato group is stable to active hydrogen functional groups at room temperature (i.e., 23° C.). The bound residual moiety of a blocking agent to the isocyanato group, which provides stability of the isocyanato group towards active hydrogen functional groups at room temperature, is referred to as a “blocking group” herein. Blocking groups may be identified by reference to the blocking agent from which they are derived by reaction with an isocyanato group. Blocking groups may be removed under suitable conditions, such as at elevated temperatures such that free isocyanato groups may be generated from the blocked isocyanato groups. Thus, the reaction with the blocking agent may be reversed at elevated temperature such that the previously blocked isocyanato group is free to react with active hydrogen functional groups. As used herein, the term “derived from” with respect to the blocking group of the blocked polyisocyanate is intended to refer to the presence of the residue of a blocking agent in the blocking group and is not intended to be limited to a blocking group produced by reaction of an isocyanato group of the polyisocyanate with the blocking agent. Accordingly, a blocking group of the present disclosure resulting from synthetic pathways that do not include direct reaction of the isocyanato group and blocking agent will still be considered to be “derived from” the blocking agent. Accordingly, the term “blocking agent” may also be used to refer to the moiety of the blocked polyisocyanate that leaves a blocking group during cure to produce a free isocyanato group. As used herein, the term “blocked” polyisocyanate curing agent” collectively refers to a fully blocked polyisocyanate curing agent and an at least partially blocked polyisocyanate curing agent. As used herein, a “fully blocked polyisocyanate curing agent” refers to a polyisocyanate wherein each of the isocyanato groups has been blocked with a blocking group. As used herein, an “at least partially blocked polyisocyanate curing agent” refers to a polyisocyanate wherein at least a portion of the isocyanato groups have been blocked with a blocking group while the remaining isocyanato groups have been reacted with a portion of the polymer backbone.

The blocked polyisocyanate curing agent comprises isocyanato groups that are reactive with the reactive groups, such as active hydrogen groups, of the ionic salt group-containing film-forming polymer to effectuate cure of the coating composition to form a coating. As used herein, the term “cure”, “cured” or similar terms, as used in connection with the electrodepositable coating compositions described herein, means that at least a portion of the components that form the electrodepositable coating composition are crosslinked to form a coating. Additionally, curing of the electrodepositable coating composition refers to subjecting said composition to curing conditions (e.g., elevated temperature) leading to the unblocking of the blocked isocyanato groups of the blocked polyisocyanate curing agent to result in reaction of the unblocked isocyanato groups of the polyisocyanate curing agent with active hydrogen functional groups of the film-forming polymer, and resulting in the crosslinking of the components of the electrodepositable coating composition and formation of an at least partially cured coating. Blocking agents removed during cure may be removed from the coating film by volatilization. Alternatively, a portion or all of the blocking agent may remain in the coating film following cure.

The polyisocyanates that may be used in preparing the blocked polyisocyanate curing agent of the present disclosure include any suitable polyisocyanate known in the art. A polyisocyanate is an organic compound comprising at least two, at least three, at least four, or more isocyanato functional groups, such as two, three, four, or more isocyanato functional groups. For example, the polyisocyanate may comprise aliphatic and/or aromatic polyisocyanates. As will be understood, an aromatic polyisocyanate will have a nitrogen atom of an isocyanate group covalently bound to a carbon present in an aromatic group, and an aliphatic polyiscoayante may contain an aromatic group that is indirectly bound to the isocyanato group through a non-aromatic hydrocarbon group. Aliphatic polyisocyanates may include, for example, (i) alkylene isocyanates, such as trimethylene diisocyanate, tetramethylene diisocyanate, pentamethylene diisocyanate, hexamethylene diisocyanate (“HDI”), 1,2-propylene diisocyanate, 1,2-butylene diisocyanate, 2,3-butylene diisocyanate, 1,3-butylene diisocyanate, ethylidene diisocyanate, and butylidene diisocyanate, and (ii) cycloalkylene isocyanates, such as 1,3-cyclopentane diisocyanate, 1,4-cyclohexane diisocyanate, 1,2-cyclohexane diisocyanate, isophorone diisocyanate, methylene bis(4-cyclohexylisocyanate) (“HMDI”), the cyclo-trimer of 1,6-hexamethylene diisocyanate (also known as the isocyanurate trimer of HDI, commercially available as Desmodur N3300 from Convestro AG), and meta-tetramethylxylylene diisocyanate (commercially available as TMXDI® from Allnex SA). Aromatic polyisocyanates may include, for example, (i) arylene isocyanates, such as m-phenylene diisocyanate, p-phenylene diisocyanate, 1,5-naphthalene diisocyanate and 1,4-naphthalene diisocyanate, and (ii) alkarylene isocyanates, such as 4,4′-diphenylene methane diisocyanate (“MDI”), 2,4-tolylene or 2,6-tolylene diisocyanate (“TDI”), or mixtures thereof, 4,4-toluidine diisocyanate and xylylene diisocyanate. Triisocyanates, such as triphenyl methane-4,4′,4″-triisocyanate, 1,3,5-triisocyanato benzene and 2,4,6-triisocyanato toluene, tetraisocyanates, such as 4,4′-diphenyldimethyl methane-2,2′,5,5′-tetraisocyanate, and polymerized polyisocyanates, such as tolylene diisocyanate dimers and trimers and the like, may also be used. The blocked polyisocyanate curing agent may also comprise a polymeric polyisocyanate, such as polymeric HDI, polymeric MDI, polymeric isophorone diisocyanate, and the like. The curing agent may also comprise a blocked trimer of hexamethylene diisocyanate available as Desmodur N3300® from Covestro AG. Mixtures of polyisocyanate curing agents may also be used.

As discussed above, the isocyanato groups of the polyisocyanate are blocked with a blocking agent such that the blocked polyisocyanate curing agent comprises blocking groups. The blocking groups may be formed by reacting the isocyanato groups with a molar ratio of blocking agents. For example, the isocyanato groups may be reacted with a 1:1 molar ratio of isocyanato groups to blocking agents such that the isocyanato groups are theoretically 100% blocked with the blocking agents. Alternatively, the molar ratio of isocyanato groups to blocking agents may be such that the isocyanato groups or blocking agent is in excess. The blocking group itself is a urethane group that contains the residues of the isocyanato group and blocking agent.

According to the present disclosure, the blocking agent may comprise a 1,2-polyol. The 1,2-polyol will react with an isocyanato group of the polyisocyanate to form a blocking group. The 1,2-polyol may comprise at least 30%, such as at least 35%, such as at least 40%, such as at least 45%, such as at least 50%, such as at least 55%, such as at least 60%, such as at least 65%, such as at least 70%, such as at least 75%, such as at least 80%, such as at least 85%, such as at least 90%, such as at least 95%, such as at least 99%, such as 100%, based upon the total number of blocking groups. The 1,2-polyol may comprise no more than 100% of the blocking groups of the blocked polyisocyanate curing agent, such as no more than 99%, such as no more than 95%, such as no more than 90%, such as no more than 85%, such as no more than 80%, such as no more than 75%, such as no more than 70%, such as no more than 65%, such as no more than 60%, such as no more than 55%, such as no more than 50%, such as no more than 45%, such as no more than 40%, such as no more than 35%, such as no more than 30%, based upon the total number of blocking groups. The 1,2-polyol may comprise 30% to 100% of the blocking groups of the blocked polyisocyanate curing agent, such as 30% to 100%, such as 35% to 100%, such as 40% to 100%, such as 45% to 100%, such as 50% to 100%, such as 55% to 100%, such as 60% to 100%, 65% to 100%, such as 70% to 100%, such as 75% to 100%, such as 80% to 100%, 85% to 100%, such as 90% to 100%, such as 95% to 100%, such as 30% to 95%, such as 35% to 95%, such as 40% to 95%, such as 45% to 95%, such as 50% to 95%, such as 55% to 95%, such as 60% to 95%, 65% to 95%, such as 70% to 95%, such as 75% to 95%, such as 80% to 95%, 85% to 95%, such as 90% to 95%, such as 30% to 90%, such as 35% to 90%, such as 40% to 90%, such as 45% to 90%, such as 50% to 90%, such as 55% to 90%, such as 60% to 90%, 65% to 90%, such as 70% to 90%, such as 75% to 90%, such as 80% to 90%, 85% to 90%, such as 30% to 85%, such as 35% to 85%, such as 40% to 85%, such as 45% to 85%, such as 50% to 85%, such as 55% to 85%, such as 60% to 85%, 65% to 85%, such as 70% to 85%, such as 75% to 85%, such as 80% to 85%, such as 30% to 80%, such as 35% to 80%, such as 40% to 80%, such as 45% to 80%, such as 50% to 80%, such as 55% to 80%, such as 60% to 80%, 65% to 80%, such as 70% to 80%, such as 75% to 80%, such as 30% to 75%, such as 35% to 75%, such as 40% to 75%, such as 45% to 75%, such as 50% to 75%, such as 55% to 75%, such as 60% to 75%, 65% to 75%, such as 70% to 75%, such as 30% to 70%, such as 35% to 70%, such as 40% to 70%, such as 45% to 70%, such as 50% to 70%, such as 55% to 70%, such as 60% to 70%, 65% to 70%, such as 30% to 65%, such as 35% to 65%, such as 40% to 65%, such as 45% to 65%, such as 50% to 65%, such as 55% to 65%, such as 60% to 65%, such as 30% to 60%, such as 35% to 60%, such as 40% to 60%, such as 45% to 60%, such as 50% to 60%, such as 55% to 60%, such as 30% to 55%, such as 35% to 55%, such as 40% to 55%, such as 45% to 55%, such as 50% to 55%, such as 30% to 50%, such as 35% to 50%, such as 40% to 50%, such as 45% to 50%, such as 30% to 45%, such as 35% to 45%, such as 40% to 45%, such as 30% to 40%, such as 35% to 40%, such as 30% to 35%, based upon the total number of blocking groups. As used herein, the percentage of blocking groups of the blocked polyisocyanate curing agent with respect to a blocking agent refers to the molar percentage of isocyanato groups blocked by that blocking agent divided by the total number of isocyanato groups actually blocked, i.e., the total number of blocking groups. The percentage of blocking groups may be determined by dividing the total moles of blocking groups blocked with a specific blocking agent by the total moles of blocking groups of the blocked polyisocyanate curing agent and multiplying by 100. It may also be expressed in equivalents of the blocking agent to total equivalents of isocyanato groups from the polyisocyanate, and the percentages and equivalents may be converted and used interchangeably (e.g., 40% of the total blocking groups is the same as 4/10 equivalents). For clarity, when reference is made to blocking groups, blocked with a blocking agent, the blocking group does not need to be derived strictly from reaction of the isocyanato group with the blocking agent and may be made by any synthetic pathway, as discussed below.

The 1,2-polyol may comprise a 1,2-alkane diol. Non-limiting examples of the 1,2-alkane diol include ethylene glycol, propylene glycol, 1,2-butane diol, 1,2-pentane diol, 1,2-hexane diol, 1,2-heptanediol, 1,2-octanediol, glycerol esters or ethers having a 1,2-dihydroxyl-functionality, and the like, and may include combinations thereof.

As discussed above, the isocyanato groups of the polyisocyanate are blocked with a blocking agent such that the blocked polyisocyanate curing agent comprises blocking groups to produce a urethane-containing compound. Accordingly, the blocked polyisocyanate curing agent may be referred to by the resulting structure that occurs after reaction of the isocyanato group and blocking agent, and the blocked polyisocyanate curing agent may comprise the structure:

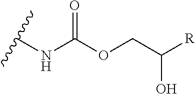

wherein R is hydrogen or a substituted or unsubstituted alkyl group comprising 1 to 8 carbon atoms, such as 1 to 6 carbon atoms, and wherein the substituted alkyl group optionally comprises an ether or ester functional group.

Although the blocked polyisocyanate curing agent is generally disclosed as being produced by reaction of the isocyanato group and blocking agent, it should be understood that any synthetic pathway that would produce the blocked polyisocyante curing agent of the structure above could be used to produce the blocked polyisocyanate curing agent of the present disclosure. For example, as shown in the reaction schematic below, an isocyanato group of a polyisocyanate (with the remainder of the polyisocyanate referred to as “X”) could be reacted with the hydroxyl-group of a hydroxyl- and epoxide-functional compound, with the result epoxide group then reacted with a hydroxyl-containing compound (wherein R is an alkyl group).

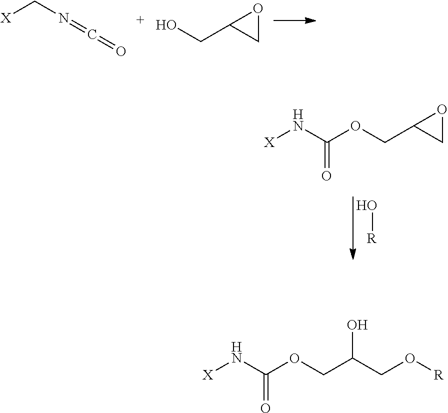

In addition to the 1,2-polyol, the blocked polyisocyanate may optionally further comprise a co-blocking agent. The co-blocking agent may comprise any suitable blocking agent. The co-blocking agent may comprise aliphatic, cycloaliphatic, or aromatic alkyl monoalcohols or phenolic compounds, including, for example, lower aliphatic alcohols, such as methanol, ethanol, and n-butanol; cycloaliphatic alcohols, such as cyclohexanol; aromatic-alkyl alcohols, such as phenyl carbinol and methylphenyl carbinol; and phenolic compounds, such as phenol itself and substituted phenols wherein the substituents do not affect coating operations, such as cresol and nitrophenol. Glycol ethers and glycol amines may also be used as blocking agents. Suitable glycol ethers include ethylene glycol butyl ether, diethylene glycol butyl ether, ethylene glycol methyl ether and propylene glycol methyl ether. Other suitable blocking agents include oximes, such as methyl ethyl ketoxime, acetone oxime and cyclohexanone oxime. Other co-blocking agents include a 1,3-alkane diol, such as, for example, 1,3-butanediol; a benzylic alcohol, for example, benzyl alcohol; an allylic alcohol, for example, allyl alcohol; caprolactam; a dialkylamine, for example dibutylamine; other diol, triol, or polyols; and mixtures thereof.

The co-blocking agent may comprise at least 1% of the blocking groups of the blocked polyisocyanate curing agent, such as at least 5%, such as at least 10%, such as at least 15%, such as at least 20%, such as at least 25%, such as at least 30%, such as at least 45%, such as at least 50%, such as at least 55%, such as at least 60%, such as at least 65%, such as 70%, based upon the total number of blocking groups. The co-blocking agent may comprise no more than 70%, such as no more than 65%, such as no more than 60%, such as no more than 55%, such as no more than 50%, such as no more than 45%, such as no more than 40%, such as no more than 35%, such as no more than 30%, such as no more than 25%, such as no more than 20%, such as no more than 15%, such as no more than 10%, such as no more than 5%, such as no more than 1%, based upon the total number of blocking groups. The co-blocking agent may comprise 1% to 70%, such as 5% to 70%, such as 10% to 70%, such as 15% to 70%, such as 20% to 70%, such as 25% to 70%, such as 30% to 70%, such as 35% to 70%, such as 40% to 70%, such as 45% to 70%, such as 50% to 70%, such as 55% to 70%, such as 60% to 70%, such as 65% to 70%, such as 1% to 65%, such as 5% to 65%, such as 10% to 65%, such as 15% to 65%, such as 20% to 65%, such as 25% to 65%, such as 30% to 65%, such as 35% to 65%, such as 40% to 65%, such as 45% to 65%, such as 50% to 65%, such as 55% to 65%, such as 60% to 65%, such as 1% to 60%, such as 5% to 60%, such as 10% to 60%, such as 15% to 60%, such as 20% to 60%, such as 25% to 60%, such as 30% to 60%, such as 35% to 60%, such as 40% to 60%, such as 45% to 60%, such as 50% to 60%, such as 55% to 60%, such as 1% to 55%, such as 5% to 55%, such as 10% to 55%, such as 15% to 55%, such as 20% to 55%, such as 25% to 55%, such as 30% to 55%, such as 35% to 55%, such as 40% to 55%, such as 45% to 55%, such as 50% to 55%, such as 1% to 50%, such as 5% to 50%, such as 10% to 50%, such as 15% to 50%, such as 20% to 50%, such as 25% to 50%, such as 30% to 50%, such as 35% to 50%, such as 40% to 50%, such as 45% to 50%, such as 1% to 45%, such as 5% to 45%, such as 10% to 45%, such as 15% to 45%, such as 20% to 45%, such as 25% to 45%, such as 30% to 45%, such as 35% to 45%, such as 40% to 45%, such as 1% to 40%, such as 5% to 40%, such as 10% to 40%, such as 15% to 40%, such as 20% to 40%, such as 25% to 40%, such as 30% to 40%, such as 35% to 40%, such as 1% to 35%, such as 5% to 35%, such as 10% to 35%, such as 15% to 35%, such as 20% to 35%, such as 25% to 35%, such as 30% to 35%, such as 1% to 30%, such as 5% to 30%, such as 10% to 30%, such as 15% to 30%, such as 20% to 30%, such as 25% to 30%, such as 1% to 25%, such as 5% to 25%, such as 10% to 25%, such as 15% to 25%, such as 20% to 25%, such as 1% to 20%, such as 5% to 20%, such as 10% to 20%, such as 15% to 20%, such as 1% to 15%, such as 5% to 15%, such as 10% to 15%, such as 1% to 10%, such as 5% to 10%, such as 1% to 5%, based upon the total number of blocking groups.

The blocked polyisocyanate curing agent may be substantially free, essentially free, or completely free of blocking groups comprising a polyester diol blocking agent formed from the reaction of ethylene glycol, propylene glycol, or 1,4-butanediol with oxalic acid, succinic acid, adipic acid, suberic acid, or sebacic acid. The blocked polyisocyanate is substantially free of blocking groups comprising a polyester diol if such groups are present in an amount of 3% or less, based upon the total number of blocking groups. The blocked polyisocyanate is essentially free of blocking groups comprising a polyester diol if such groups are present in an amount of 1% or less, based upon the total number of blocking groups. The blocked polyisocyanate is completely free of blocking groups comprising a polyester diol is such groups are not present, i.e., 0%, based upon the total number of blocking groups.

The curing agent may be present in the cationic electrodepositable coating composition in an amount of at least 10% by weight, such as at least 20% by weight, such as at least 25% by weight and may be present in an amount of no more than 60% by weight, such as no more than 50% by weight, such as no more than 40% by weight, based on the total weight of the resin solids of the electrodepositable coating composition. The curing agent may be present in the cationic electrodepositable coating composition in an amount of 10% to 60% by weight, such as 20% to 50% by weight, such as 25% to 40% by weight, based on the total weight of the resin solids of the electrodepositable coating composition.

The curing agent may be present in the anionic electrodepositable coating composition in an amount of at least 10% by weight, such as at least 20% by weight, such as at least 25% by weight, and may be present in an amount of no more than 50% by weight, such as no more than 45% by weight, such as no more than 40% by weight, based on the total weight of the resin solids of the electrodepositable coating composition. The curing agent may be present in the anionic electrodepositable coating composition in an amount of 10% to 50% by weight, such as 20% to 45% by weight, such as 25% to 40% by weight, based on the total weight of the resin solids of the electrodepositable coating composition.

### Bismuth Catalyst

According to the present disclosure, the electrodepositable coating composition of the present disclosure comprises a bismuth catalyst.

As used herein, the term “bismuth catalyst” refers to catalysts that contain bismuth and catalyze transurethanation reactions, and specifically catalyze the deblocking of the blocked polyisocyanate curing agent blocking groups.

The bismuth catalyst may comprise a soluble bismuth catalyst. As used herein, a “soluble” or “solubilized” bismuth catalyst is at catalyst wherein at least 35% of the bismuth catalyst dissolves in an aqueous medium having a pH in the range of 4 to 7 at room temperature (e.g., 23° C.). The soluble bismuth catalyst may provide solubilized bismuth metal in an amount of at least 0.04% by weight, based on the total weight of the electrodepositable coating composition.

Alternatively, the bismuth catalyst may comprise an insoluble bismuth catalyst. As used herein, an “insoluble” bismuth catalyst is at catalyst wherein less than 35% of the catalyst dissolves in an aqueous medium having a pH in the range of 4 to 7 at room temperature (e.g., 23° C.). The insoluble bismuth catalyst may provide solubilized bismuth metal in an amount of less than 0.04% by weight, based on the total weight of the electrodepositable coating composition.

The percentage of solubilized bismuth catalyst present in the composition may be determined using ICP-MS to calculate the total amount of bismuth metal (i.e., soluble and insoluble) and total amount of solubilized bismuth metal and calculating the percentage using those measurements.

The bismuth catalyst may comprise a bismuth compound and/or complex.

The bismuth catalyst may, for example, comprise a colloidal bismuth oxide or bismuth hydroxide, a bismuth compound complex such as, for example, a bismuth chelate complex, or a bismuth salt of an inorganic or organic acid, wherein the term “bismuth salt” includes not only salts comprising bismuth cations and acid anions, but also bismuthoxy salts.

Examples of inorganic or organic acids from which the bismuth salts may be derived are hydrochloric acid, sulphuric acid, nitric acid, inorganic or organic sulphonic acids, carboxylic acids, for example, formic acid or acetic acid, amino carboxylic acids and hydroxy carboxylic acids, such as lactic acid or dimethylolpropionic acid.

Non-limiting examples of bismuth salts are aliphatic hydroxycarboxylic acid salts of bismuth, such as lactic acid salts or dimethylolpropionic acid salts of bismuth, for example, bismuth lactate or bismuth dimethylolpropionate; bismuth subnitrate; amidosulphonic acid salts of bismuth; hydrocarbylsulphonic acid salts of bismuth, such as alkyl sulphonic acid salts, including methane sulphonic acid salts of bismuth, for example, bismuth methane sulphonate. Further non-limiting examples of bismuth compound or complex catalysts include bismuth oxides, bismuth carboxylates, bismuth sulfamate, bismuth sulphonate, and combinations thereof.

The bismuth catalyst may be present in an amount of at least 0.01% by weight of bismuth metal, such as at least 0.1% by weight, such as at least 0.2% by weight, such as at least 0.5% by weight, such as at least 1% by weight, such as 1% by weight, based on the total resin solids weight of the composition. The bismuth catalyst may be present in an amount of no more than 3% by weight of bismuth metal, such as no more than 1.5% by weight, such as no more than 1% by weight, based on the total resin solids weight of the composition. The bismuth catalyst may be present in an amount of 0.01% to 3% by weight of bismuth metal, such as 0.1% to 1.5% by weight, such as 0.2% to 1% by weight, such as 0.5% to 3% by weight, such as 0.5% to 1.5% by weight, such as 0.5% to 1% by weight, such as 1% to 3% by weight, such as 1% to 1.5% by weight, based on the total resin solids weight of the composition.

The bismuth catalyst may be present in an amount such that the amount of solubilized bismuth metal may be at least 0.04% by weight, based on the total weight of the electrodepositable coating composition, such as at least 0.06% by weight, such as at least 0.07% by weight, such as at least 0.08% by weight, such as at least 0.09% by weight, such as at least 0.10% by weight, such as at least 0.11% by weight, such as at least 0.12% by weight, such as at least 0.13% by weight, such as at least 0.14% by weight, or higher. The bismuth catalyst may be present in an amount such that the amount of solubilized bismuth metal of no more than 0.30% by weight, based on the total weight of the electrodepositable coating composition.

The bismuth catalyst may be present in an amount such that the amount of solubilized bismuth metal may be at least 0.22% by weight, based on the total weight of the resin solids, such as at least 0.30% by weight, such as at least 0.34% by weight, such at least 0.40% by weight, such as at least 0.45% by weight, such as 0.51% by weight, such as at least 0.56% by weight, such as at least 0.62% by weight, such as at least 0.68% by weight, such as at least 0.73% by weight, such as at least 0.80% by weight, or higher.

It has been surprisingly discovered that electrodepositable coating compositions that include the blocked polyisocyanate curing agent comprising blocking groups, wherein at least 30% of the blocking groups comprise a 1,2-polyol as a blocking agent, based upon the total number of blocking groups, and a bismuth catalyst produce a synergistic cure effect such that the compositions cure at low temperatures. For example, the electrodepositable coating compositions of the present disclosure may cure (T_{Cure}) at a temperature of less than 150° C., such as 140° C. or less, when measured by a standardized test method. For example, the electrodepositable coating compositions of the present disclosure may cure (T_{Cure}) at a temperature of less than 170° C., such as 160° C. or less, such as 155° C. or less, such as 150° C. or less, such as 145° C. or less, such as 142° C. or less, when measured by a standardized test method.

For example, the electrodepositable coating composition may cure at a temperature at least 10° C. lower than a comparative electrodepositable coating composition, such as at least 7° C. lower than a comparative electrodepositable coating composition, such as at least 5° C. lower than a comparative electrodepositable coating composition, such as at least 3° C. lower than a comparative electrodepositable coating composition, as measured by a standardized test method. For example, the electrodepositable coating composition may cure at a temperature at least 10° C. lower than a comparative electrodepositable coating composition, such as at least 7° C. lower than a comparative electrodepositable coating composition, such as at least 5° C. lower than a comparative electrodepositable coating composition, such as at least 3° C. lower than a comparative electrodepositable coating composition, as measured by a standardized test method. As used herein, a “comparative electrodepositable coating composition” is a composition having the same ionic-film-forming polymer and meets one of the following conditions: (1) a composition with the blocked polyisocyanate curing agent of the present disclosure with no catalyst; (2) a composition with the blocked polyisocyanate curing agent of the present disclosure with a catalyst other than a bismuth catalyst; (3) a composition with the blocked polyisocyanate curing agent of the present disclosure with a catalyst different than the bismuth catalyst of the present disclosure (including alternative forms of bismuth catalysts); or (4) a composition with a different blocked polyisocyanate curing agent than described here (i.e., without a 1,2-polyol blocking agent in the amount described herein) with or without a catalyst that may include a bismuth catalyst.

The bismuth catalyst is provided in an amount of at least 0.5% by weight bismuth metal, based on the total resin solids weight of the composition, and the 1,2-polyol may comprise a percentage of the blocking groups of the blocked polyisocyanate curing agent, the percentage being greater than or equal to [(−1.2x+1.6)*100]% or 30%, whichever is higher, wherein x is the weight percent of bismuth metal, and the percentage of blocking groups is based upon the total number of blocking groups.

### Further Components of the Electrodepositable Coating Compositions

The electrodepositable coating composition according to the present disclosure may optionally comprise one or more further components in addition to the ionic salt group-containing film-forming polymer, the blocked polyisocyanate curing agent, and the bismuth catalyst described above.

According to the present disclosure, the electrodepositable coating composition may optionally comprise a co-catalyst to further catalyze the reaction between the blocked polyisocyanate curing agent and the film-forming polymers. Examples of co-catalysts suitable for cationic electrodepositable coating compositions include, without limitation, organotin compounds (e.g., dibutyltin oxide and dioctyltin oxide) and salts thereof (e.g., dibutyltin diacetate); other metal oxides (e.g., oxides of cerium and zirconium) and salts thereof. Examples of catalysts suitable for anionic electrodepositable coating compositions include latent acid catalysts, specific examples of which are identified in WO 2007/118024 at [0031] and include, but are not limited to, ammonium hexafluoroantimonate, quaternary salts of SbF₆ (e.g., NACURE® XC-7231), t-amine salts of SbF₆ (e.g., NACURE® XC-9223), Zn salts of triflic acid (e.g., NACURE® A202 and A218), quaternary salts of triflic acid (e.g., NACURE® XC-A230), and diethylamine salts of triflic acid (e.g., NACURE® A233), all commercially available from King Industries, and/or mixtures thereof. Latent acid catalysts may be formed by preparing a derivative of an acid catalyst such as para-toluenesulfonic acid (pTSA) or other sulfonic acids. For example, a well-known group of blocked acid catalysts are amine salts of aromatic sulfonic acids, such as pyridinium para-toluenesulfonate. Such sulfonate salts are less active than the free acid in promoting crosslinking. During cure, the catalysts may be activated by heating.

The co-catalyst may be present in the electrodepositable coating composition in amounts of 0.01% to 3% by weight, based on total weight of the resin solids of the electrodepositable coating composition.

Alternatively, the electrodepositable coating composition may be substantially free, essentially free, or completely free of a co-catalyst. As used herein, an electrodepositable coating composition is “substantially free” of a co-catalyst if the co-catalyst is present, if at all, in an amount less than 0.01% by weight, based on the total resin solids weight of the composition. As used herein, an electrodepositable coating composition is “essentially free” of a co-catalyst if the co-catalyst is present, if at all, in trace or incidental amounts insufficient to affect any properties of the composition, such as, e.g., less than 0.001% by weight, based on the total resin solids weight of the composition. As used herein, an electrodepositable coating composition is “substantially free” of a co-catalyst if the co-catalyst is not present in the composition, i.e., 0.000% by weight, based on the total resin solids weight of the composition.

The co-catalyst may comprise a zinc-containing catalyst. The zinc-containing catalyst may comprise a metal salt and/or complex of zinc. For example, the zinc-containing curing catalyst may comprise a zinc (II) amidine complex, zinc octoate, zinc naphthenate, zinc tallate, zinc carboxylates having from about 8 to 14 carbons in the carboxylate group, zinc acetate, zinc sulfonates, zinc methanesulfonates, or any combination thereof.

The zinc (II) amidine complex contains amidine and carboxylate ligands. More specifically, the zinc (II) amidine complex comprises compounds having the formula Zn(A)₂(C)₂ wherein A represents an amidine and C represents a carboxylate. More specifically, A may be represented by the formula (1) or (2):

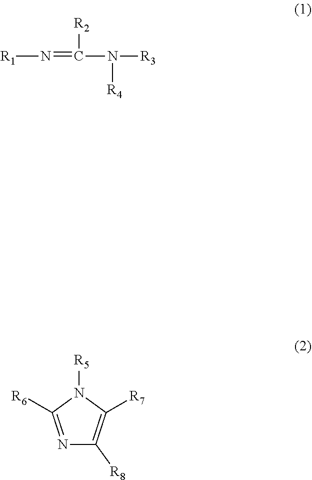

wherein R¹ and R³ are each independently hydrogen or an organic group attached through a carbon atom or are joined to one another by an N═C—N linkage to form a heterocyclic ring with one or more hetero atoms or a fused bicyclic ring with one or more heteroatoms; R² is hydrogen, an organic group attached through a carbon atom, an amine group which is optionally substituted, or a hydroxyl group which is optionally etherified with a hydrocarbyl group having up to 8 carbon atoms; R⁴ is hydrogen, an organic group attached through a carbon atom or a hydroxyl group which can be optionally etherified with a hydrocarbyl group having up to 8 carbon atoms; and R⁵, R⁶, R⁷ and R⁸ are independently hydrogen, alkyl substituted alkyl hydroxyalkyl, aryl, aralkyl, cycloalkyl, heterocyclics, ether, thioether, halogen, N(R)₂, polyethylene polyamines, nitro groups, keto groups, ester groups, or carbonamide groups optionally alkyl substituted with alkyl substituted alkyl hydroxyalkyl, aryl, aralkyl, cycloalkyl, heterocycles, ether, thioether, halogen, N(R)₂, polyethylene polyamines, nitro groups, keto groups or ester groups; and C is an aliphatic, aromatic or polymeric carboxylate with an equivalent weight of 45 to 465.

The zinc-containing curing catalyst may be present in the coating composition in an amount of at least 0.1% by weight, based on the total weight of the resin solids of the coating composition, such as at least 0.2% by weight, such as at least 0.5% by weight, such as at least 0.8% by weight, such as at least 1% by weight, such as at least 1.5% by weight. The zinc-containing curing catalyst may be present in the coating composition in an amount of no more than 7% by weight, based on the total weight of the resin solids of the coating composition, such as no more than 4% by weight, such as no more than 2% by weight, such as no more than 1.5% by weight, such as no more than 1% by weight. The zinc-containing curing catalyst may be present in the coating composition in an amount of 0.1% to 7% by weight, based on the total weight of the resin solids of the coating composition, such as 0.1% to 4% by weight, such as 0.1% to 2% by weight, such as 0.1% to 1.5% by weight, such as 0.1% to 1% by weight, such as 0.2% to 7% by weight, such as 0.2% to 4% by weight, such as 0.2% to 2% by weight, such as 0.2% to 1.5% by weight, such as 0.2% to 1% by weight, such as 0.5% to 7% by weight, such as 0.5% to 4% by weight, such as 0.5% to 2% by weight, such as 0.5% to 1.5% by weight, such as 0.5% to 1% by weight, such as 0.8% to 7% by weight, such as 0.8% to 4% by weight, such as 0.8% to 2% by weight, such as 0.8% to 1.5% by weight, such as 0.8% to 1% by weight, such as 1% to 7% by weight, such as 1% to 4% by weight, such as 1% to 2% by weight, such as 1% to 1.5% by weight, such as 1.5% to 7% by weight, such as 1.5% to 4% by weight, such as 1.5% to 2% by weight.

According to the present disclosure, the electrodepositable coating composition may optionally further comprise a guanidine. It will be understood that “guanidine,” as used herein, refers to guanidine and derivatives thereof. For example, the guanidine may comprise a compound, moiety, and/or residue having the following general structure:

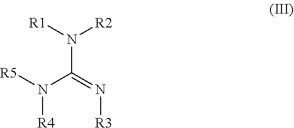

wherein each of R1, R2, R3, R4, and R5 (i.e., substituents of structure (III)) comprise hydrogen, (cyclo)alkyl, aryl, aromatic, organometallic, a polymeric structure, or together can form a cycloalkyl, aryl, or an aromatic structure, and wherein R1, R2, R3, R4, and R5 may be the same or different. As used herein, “(cyclo)alkyl” refers to both alkyl and cycloalkyl. When any of the R groups “together can form a (cyclo)alkyl, aryl, and/or aromatic group” it is meant that any two adjacent R groups are connected to form a cyclic moiety, such as the rings in structures (IV)-(VII) below.

It will be appreciated that the double bond between the carbon atom and the nitrogen atom that is depicted in structure (III) may be located between the carbon atom and another nitrogen atom of structure (III). Accordingly, the various substituents of structure (III) may be attached to different nitrogen atoms depending on where the double bond is located within the structure.

The guanidine may comprise a cyclic guanidine such as a guanidine of structure (III) wherein two or more R groups of structure (III) together form one or more rings. In other words, the cyclic guanidine may comprise ≥1 ring(s).

The cyclic guanidine may comprise a bicyclic guanidine, and the bicyclic guanidine may comprise 1,5,7-triazabicyclo[4.4.0]dec-5-ene (“TBD” or “BCG”).

The guanidine is present in the electrodepositable coating composition such that a weight ratio of bismuth metal from the solubilized bismuth catalyst to guanidine of from 1.00:0.071 to 1.0:2.1, such as from 1.0:0.17 to 1.0:2.0, such as from 1.0:0.33 to 1.0:1.33, such as from 1.0:0.47 to 1.0:1.0.

The guanidine is present in the electrodepositable coating composition such that a molar ratio of bismuth metal to guanidine of from 1.0:0.25 to 1.0:3.0, such as from 1:0.5 to 1.0:2.0, such as from 1:0.7 to 1:1.5.

It has been surprisingly discovered that the addition of a guanidine to a bismuth-catalyzed electrodepositable coating composition allows for the production of an electrodepositable coating composition that maintains cure even as the concentration of phosphate ions increases. Sufficient cure performance may be maintained despite phosphate ions present in the electrodepositable coating composition. For example, the electrodepositable coating composition may achieve cure with phosphate ions present in the electrodepositable coating composition in an amount of 1 to 1,000 ppm, such as 1 to 800 ppm, such as 1 to 500 ppm, such as 1 to 300 ppm, such as 1 to 200 ppm, such as 100 to 1,000 ppm, such as 100 to 800 ppm, such as 100 to 500 ppm, such as 100 to 300 ppm, such as 100 to 200 ppm, such as 200 to 1,000 ppm, such as 200 to 800 ppm, such as 200 to 500 ppm, such as 200 to 300 ppm, such as 300 to 1,000 ppm, such as 300 to 800 ppm, such as 300 to 500 ppm.

According to the present disclosure, the electrodepositable coating compositions of the present disclosure may optionally comprise a corrosion inhibitor. Any suitable corrosion inhibitor may be used. For example, the corrosion inhibitor may comprise a corrosion inhibitor comprising yttrium, lanthanum, cerium, calcium, an azole, or any combination thereof.

Non-limiting examples of suitable azoles include benzotriazole, 5-methyl benzotriazole, 2-amino thiazole, as well as salts thereof.

The corrosion inhibitor(s) may be present, if at all, in the electrodepositable coating composition in an amount of 0.001% to 25% by weight, such as 0.001% to 15% by weight, such as 0.001% to 10% by weight, such as 5% to 25% by weight, such as 5% to 15% by weight, such as 5% to 10% by weight, based on the total weight of the electrodepositable coating composition.

Alternatively, the electrodepositable coating composition may be substantially free, essentially free, or completely free of a corrosion inhibitor.

According to the present disclosure, the electrodepositable coating composition may optionally further comprise a silane. The silane may comprise a functional group such as, for example, hydroxyl, carbamate, epoxy, isocyanate, amine, amine-salt, mercaptan, or combinations thereof. The silane may comprise, for example, an aminosilane, a mercaptosilane, or combinations thereof. Mixtures of an aminosilane and a silane having an unsaturated group, such as vinyltriacetoxysilane, may also be used.

The silane may be present, if at all, in the electrodepositable coating composition in an amount of 0.01% to 5% by weight, such as 0.01% to 3% by weight, such as 0.01% to 1% by weight, such as 0.1% to 5% by weight, such as 0.01% to 3% by weight, such as 0.1% to 1% by weight, such as 1% to 5% by weight, such as 1% to 3% by weight, such as 3% to 5% by weight, based on the total weight of the resin solids.

Alternatively, the electrodepositable coating composition may be substantially free, essentially free, or completely free of a silane.

The electrodepositable coating composition may optionally further comprise a pigment. The pigment may comprise an iron oxide, a lead oxide, strontium chromate, carbon black, coal dust, titanium dioxide, barium sulfate, a color pigment, a phyllosilicate pigment, a metal pigment, a thermally conductive, electrically insulative filler, fire-retardant pigment, or any combination thereof.

The pigment may comprise, consist essentially of, or consist of titanium dioxide, barium sulfate, or any combination thereof.

Titanium dioxide and/or barium sulfate may be present in an amount of at least 10% by weight, such as at least 20% by weight, such as at least 30% by weight, such as at least 40% by weight, such as at least 50% by weight, based on the total weight of pigment, such as at least 60% by weight, such as at least 70% by weight, such as at least 75% by weight, such as at least 80% by weight, such as at least 90% by weight, such as at least 95% by weight, such as at least 98% by weight, such as 100% by weight, based on the total amount of pigment. Titanium dioxide and/or barium sulfate may be present in an amount of 100% by weight, such as no more than 95% by weight, such as no more than 90% by weight, such as no more than 80% by weight, such as no more than 70% by weight, such as no more than 60% by weight, such as no more than 50% by weight, such as no more than 40% by weight, such as no more than 30% by weight, such as no more than 20% by weight, based on the total amount of pigment. Titanium dioxide and/or barium sulfate may be present in an amount of 10% to 100% by weight, based on the total weight of pigment, such as 10% to 95%, such as 10% to 90%, such as 10% to 80%, such as 10% to 70%, such as 10% to 60%, such as 10% to 50%, such as 10% to 40%, such as 10% to 30%, such as 10% to 20%, such as 20% to 100% by weight, such as 20% to 95%, such as 20% to 90%, such as 20% to 80%, such as 20% to 70%, such as 20% to 60%, such as 20% to 50%, such as 20% to 40%, such as 20% to 30%, such as 30% to 100% by weight, such as 30% to 95%, such as 30% to 90%, such as 30% to 80%, such as 30% to 70%, such as 30% to 60%, such as 30% to 50%, such as 30% to 40%, such as 40% to 100% by weight, such as 40% to 95%, such as 40% to 90%, such as 40% to 80%, such as 40% to 70%, such as 40% to 60%, such as 40% to 50%, such as 50% to 100%, such as 50% to 95%, such as 50% to 90%, such as 50% to 80%, such as 50% to 70%, such as 60% to 100%, such as 60% to 95%, such as 60% to 90%, such as 60% to 80%, such as 60% to 70%, such as 70% to 100%, such as 70% to 95%, such as 70% to 90%, such as 70% to 80%, such as 80% to 100%, such as 80% to 95%, such as 80% to 90%, such as 90% to 100%, such as 90% to 95%.

Titanium dioxide and/or barium sulfate may be present in an amount of at least 1% by weight, based on the total composition solids weight, such as at least 5% by weight, such as at least 10% by weight, such as at least 15% by weight, such as at least 20% by weight, such as at least 30% by weight, such as at least 40% by weight, such as at least 50% by weight. Titanium dioxide and/or barium sulfate may be present in an amount of no more than 66% by weight, based on the total composition solids weight, such as no more than 50% by weight, such as no more than 40% by weight, such as no more than 30% by weight, such as no more than 20% by weight, such as no more than 15% by weight, such as no more than 10% by weight. Titanium dioxide and/or barium sulfate may be present in an amount of 1% to 66% by weight, based on the total composition solids weight, such as 1% to 50% by weight, such as 1% to 40% by weight, such as 1% to 30% by weight, such as 1% to 20% by weight, such as 1% to 15% by weight, such as 1% to 10% by weight, 5% to 66% by weight, such as 5% to 50% by weight, such as 5% to 40% by weight, such as 5% to 30% by weight, such as 5% to 20% by weight, such as 5% to 15% by weight, such as 5% to 10% by weight, such as 10% to 66% by weight, such as 10% to 50% by weight, such as 10% to 40% by weight, such as 10% to 30% by weight, such as 10% to 20% by weight, such as 10% to 15% by weight, such as 15% to 66% by weight, such as 15% to 50% by weight, such as 15% to 40% by weight, such as 15% to 30% by weight, such as 15% to 20% by weight, such as 20% to 66% by weight, such as 20% to 50% by weight, such as 20% to 40% by weight, such as 20% to 30% by weight, such as 30% to 66% by weight, such as 30% to 50% by weight, such as 30% to 40% by weight, such as 40% to 66% by weight, such as 40% to 50% by weight, such as 50% to 66% by weight.

The pigment-to-binder (P:B) ratio as set forth in this disclosure may refer to the weight ratio of the pigment-to-binder in the electrodepositable coating composition, and/or the weight ratio of the pigment-to-binder in the deposited wet film, and/or the weight ratio of the pigment to the binder in the dry, uncured deposited film, and/or the weight ratio of the pigment-to-binder in the cured film. The pigment-to-binder (P:B) ratio of the pigment to the electrodepositable binder may be at least 0.05:1, such as at least 0.1:1, such as at least 0.2:1, such as at least 0.30:1, such as at least 0.35:1, such as at least 0.40:1, such as at least 0.50:1, such as at least 0.60:1, such as at least 0.75:1, such as at least 1:1, such as at least 1.25:1, such as at least 1.5:1. The pigment-to-binder (P:B) ratio of the pigment to the electrodepositable binder may be no more than 2.0:1, such as no more than 1.75:1, such no more than 1.5:1, such as no more than 1.25:1, such as no more than 1:1, such as no more than 0.75:1, such as no more than 0.70:1, such as no more than 0.60:1, such as no more than 0.55:1, such as no more than 0.50:1, such as no more than 0.30:1, such as no more than 0.20:1, such as no more than 0.10:1. The pigment-to-binder (P:B) ratio of the pigment to the electrodepositable binder may be 0.05:1 to 2.0:1, such as 0.05:1 to 1.75:1, such as 0.05:1 to 1.50:1, such as 0.05:1 to 1.25:1, such as 0.05:1 to 1:1, such as 0.05:1 to 0.75:1, such as 0.05:1 to 0.70:1, such as 0.05:1 to 0.60:1, such as 0.05:1 to 0.55:1, such as 0.05:1 to 0.50:1, such as 0.05:1 to 0.30:1, such as 0.05:1 to 0.20:1, such as 0.05:1 to 0.10:1, such as 0.1:1 to 2.0:1, such as 0.1:1 to 1.75:1, such as 0.1:1 to 1.50:1, such as 0.1:1 to 1.25:1, such as 0.1:1 to 1:1, such as 0.1:1 to 0.75:1, such as 0.1:1 to 0.70:1, such as 0.1:1 to 0.60:1, such as 0.1:1 to 0.55:1, such as 0.1:1 to 0.50:1, such as 0.1:1 to 0.30:1, such as 0.1:1 to 0.20:1, such as 0.2:1 to 2.0:1, such as 0.2:1 to 1.75:1, such as 0.2:1 to 1.50:1, such as 0.2:1 to 1.25:1, such as 0.2:1 to 1:1, such as 0.2:1 to 0.75:1, such as 0.2:1 to 0.70:1, such as 0.2:1 to 0.60:1, such as 0.2:1 to 0.55:1, such as 0.2:1 to 0.50:1, such as 0.2:1 to 0.30:1, such as 0.3:1 to 2.0:1, such as 0.3:1 to 1.75:1, such as 0.3:1 to 1.50:1, such as 0.3:1 to 1.25:1, such as 0.3:1 to 1:1, such as 0.3:1 to 0.75:1, such as 0.3:1 to 0.70:1, such as 0.3:1 to 0.60:1, such as 0.3:1 to 0.55:1, such as 0.3:1 to 0.50:1, such as 0.3:1 to 0.30:1, such as 0.35:1 to 2.0:1, such as 0.35:1 to 1.75:1, such as 0.35:1 to 1.50:1, such as 0.35:1 to 1.25:1, such as 0.35:1 to 1:1, such as 0.35:1 to 0.75:1, such as 0.35:1 to 0.70:1, such as 0.35:1 to 0.60:1, such as 0.35:1 to 0.55:1, such as 0.35:1 to 0.50:1, such as 0.4:1 to 2.0:1, such as 0.4:1 to 1.75:1, such as 0.4:1 to 1.50:1, such as 0.4:1 to 1.25:1, such as 0.4:1 to 1:1, such as 0.4:1 to 0.75:1, such as 0.4:1 to 0.70:1, such as 0.4:1 to 0.60:1, such as 0.4:1 to 0.55:1, such as 0.4:1 to 0.50:1, such as 0.5:1 to 2.0:1, such as 0.5:1 to 1.75:1, such as 0.5:1 to 1.50:1, such as 0.5:1 to 1.25:1, such as 0.5:1 to 1:1, such as 0.5:1 to 0.75:1, such as 0.5:1 to 0.70:1, such as 0.5:1 to 0.60:1, such as 0.5:1 to 0.55:1, such as 0.6:1 to 2.0:1, such as 0.6:1 to 1.75:1, such as 0.6:1 to 1.50:1, such as 0.6:1 to 1.25:1, such as 0.6:1 to 1:1, such as 0.6:1 to 0.75:1, such as 0.6:1 to 0.70:1, such as 0.75:1 to 2.0:1, such as 0.75:1 to 1.75:1, such as 0.75:1 to 1.50:1, such as 0.75:1 to 1.25:1, such as 0.75:1 to 1:1, such as 1:1 to 2.0:1, such as 1:1 to 1.75:1, such as 1:1 to 1.50:1, such as 1:1 to 1.25:1, such as 1.25:1 to 2.0:1, such as 1.25:1 to 1.75:1, such as 1.25:1 to 1.50:1, such as 1.50:1 to 2.0:1, such as 1.50:1 to 1.75:1.

When pigment is present, the electrodepositable coating composition may comprise less than 50% by weight of phyllosilicate pigment, based on the total weight of pigment, such as less than 40% by weight, such as less than 30% by weight, such as less than 25% by weight, such as less than 20% by weight.

When pigment is present, the electrodepositable coating composition may comprise less than 50% by weight of phyllosilicate pigment, based on the total weight of pigment, if the electrodepositable coating composition has a pigment-to-binder ratio of 0.5:1 or less, such as less than 40% by weight, such as less than 30% by weight, such as less than 25% by weight, such as less than 20% by weight.

As used herein, the term “phyllosilicate” refers to a group of minerals having sheets of silicates having a basic structure based on interconnected six membered rings of SiO₄⁻⁴ tetrahedra that extend outward in infinite sheets where 3 out of the 4 oxygens from each tetrahedra are shared with other tetrahedra resulting in phyllosilicates having the basic structural unit of Si₂O₅⁻². Phyllosilicates may comprise hydroxide ions located at the center of the tetrahedra and/or cations such as, for example, Fe⁺², Mg⁺², or Al⁺³, that form cation layers between the silicate sheets where the cations may coordinate with the oxygen of the silicate layer and/or the hydroxide ions. The term “phyllosilicate pigment” refers to pigment materials comprising phyllosilicates. Non-limiting examples of phyllosilicate pigments includes the micas, chlorites, serpentine, talc, and the clay minerals. The clay minerals include, for example, kaolin clay and smectite clay. The sheet-like structure of the phyllosilicate pigment tends to result in pigment having a plate-like structure, although the pigment can be manipulated (such as through mechanical means) to have other particle structures.

The electrodepositable coating composition may optionally further comprise a grind resin. As used herein, the term “grind resin” refers to a resin chemically distinct from the main film-forming polymer that is used during milling of pigment to form a pigment paste separately from the main film-forming polymer of the binder. For example, the grind resin may include quaternary ammonium salt groups and/or tertiary sulfonium groups. Grind resin may be used interchangeably with grind vehicle.

Alternatively, the electrodepositable coating composition optionally may be substantially free, essentially free, or completely free of a grind resin. As used herein, an electrodepositable coating composition is substantially free of grind resin if grind resin is present, if at all, in an amount of no more than 5% by weight, based on the total resin solids weight of the composition. As used herein, an electrodepositable coating composition is essentially free of grind resin if grind resin is present, if at all, in an amount no more than 3% by weight, based on the total resin solids weight of the composition. As used here, an electrodepositable coating composition is completely free of grind resin if grind resin is not present in the composition, i.e., 0.00% by weight, based on the total resin solids weight of the composition.

The electrodepositable coating composition may be substantially free, essentially free, or completely free of electrically conductive particles. The electrically conductive particles may comprise any particles capable of conducting electricity. As used herein, an electrically conductive particle is “capable of conducting electricity” if the material has a conductivity of at least 1×10⁵ S/m and a resistivity of no more than 1×10⁶ W-m at 20° C. The electrically conductive particles may include carbonaceous materials such as, activated carbon, carbon black such as acetylene black and furnace black, graphene, carbon nanotubes, including single-walled carbon nanotubes and/or multi-walled carbon nanotubes, carbon fibers, fullerene, metal particles, and combinations thereof. As used herein, an electrodepositable coating composition is substantially free of electrically conductive particles if electrically conductive particles are present in an amount of less than 5% by weight, based on the total weight of the pigment of the composition. As used herein, an electrodepositable coating composition is essentially free of electrically conductive particles if electrically conductive particles are present in an amount of less than 1% by weight, based on the total weight of the pigment of the composition. As used here, an electrodepositable coating composition is completely free of electrically conductive particles if electrically conductive particles are not present in the composition, i.e., 0.00% by weight, based on the total weight of the pigment of the composition.

The electrodepositable coating composition may be substantially free, essentially free, or completely free of metal particles. As used herein, the term “metal particles” refers to metal and metal alloy pigments that consist primarily of metal(s) in the elemental (zerovalent) state. The metal particles may include zinc, aluminum, cadmium, magnesium, beryllium, copper, silver, gold, iron, titanium, nickel, manganese, chromium, scandium, yttrium, zirconium, platinum, tin, and alloys thereof, as well as various grades of steel. As used herein, an electrodepositable coating composition is substantially free of metal particles if metal particles are present in an amount of less than 5% by weight, based on the total weight of the pigment of the composition. As used herein, an electrodepositable coating composition is essentially free of metal particles if metal particles are present in an amount of less than 1% by weight, based on the total weight of the pigment of the composition. As used here, an electrodepositable coating composition is completely free of metal particles if metal particles are not present in the composition, i.e., 0.00% by weight, based on the total weight of the pigment of the composition.

The electrodepositable coating composition of the present disclosure may be substantially free, essentially free, or completely free of lithium-containing compounds. As used herein, lithium-containing compounds refers to compounds or complexes that comprise lithium, such as, for example, LiCoC, LiNiC, LiFePO₄, LiCoPCO₄, LiMnO₂, LiMn₂O₄, Li(NiMnCo)O₂, and Li(NiCoAl)O₂. As used herein, an electrodepositable coating composition is “substantially free” of lithium-containing compounds if lithium-containing compounds are present in the electrodepositable coating composition in an amount of less than 1% by weight, based on the total solids weight of the composition. As used herein, an electrodepositable coating composition is “essentially free” of lithium-containing compounds if lithium-containing compounds are present in the electrodepositable coating composition in an amount of less than 0.1% by weight, based on the total solids weight of the composition. As used herein, an electrodepositable coating composition is “completely free” of lithium-containing compounds if lithium-containing compounds are not present in the electrodepositable coating composition, i.e., <0.001% by weight, based on the total solids weight of the composition.

The electrodepositable coating composition may be substantially free, essentially free, or completely free of tin. As used herein, an electrodepositable coating composition is “substantially free” of tin if tin is present, if at all, in an amount less than 0.01% by weight, based on the total resin solids weight of the composition. As used herein, an electrodepositable coating composition is “essentially free” of tin if tin is present, if at all, in trace or incidental amounts insufficient to affect any properties of the composition, such as, e.g., less than 0.001% by weight, based on the total resin solids weight of the composition. As used herein, an electrodepositable coating composition is “completely free” of tin if tin is not present in the composition, i.e., 0.000% by weight, based on the total resin solids weight of the composition.

The electrodepositable coating composition may be substantially free, essentially free, or completely free of bismuth subnitrate. As used herein, an electrodepositable coating composition is “substantially free” of bismuth subnitrate if bismuth subnitrate is present, if at all, in an amount less than 0.01% by weight, based on the total resin solids weight of the composition. As used herein, an electrodepositable coating composition is “essentially free” of bismuth subnitrate if bismuth subnitrate is present, if at all, in trace or incidental amounts insufficient to affect any properties of the composition, such as, e.g., less than 0.001% by weight, based on the total resin solids weight of the composition. As used herein, an electrodepositable coating composition is “completely free” of bismuth subnitrate if bismuth subnitrate is not present in the composition, i.e., 0.000% by weight, based on the total resin solids weight of the composition.

The electrodepositable coating composition may be substantially free, essentially free, or completely free of bismuth oxide. As used herein, an electrodepositable coating composition is “substantially free” of bismuth oxide if bismuth oxide is present, if at all, in an amount less than 0.01% by weight, based on the total resin solids weight of the composition. As used herein, an electrodepositable coating composition is “essentially free” of bismuth oxide if bismuth oxide is present, if at all, in trace or incidental amounts insufficient to affect any properties of the composition, such as, e.g., less than 0.001% by weight, based on the total resin solids weight of the composition. As used herein, an electrodepositable coating composition is “completely free” of bismuth oxide if bismuth oxide is not present in the composition, i.e., 0.000% by weight, based on the total resin solids weight of the composition.

The electrodepositable coating composition may be substantially free, essentially free, or completely free of bismuth silicate, bismuth titanate, bismuth sulfamate, and/or bismuth lactate. As used herein, an electrodepositable coating composition is “substantially free” of any of such materials (each individually) if the material is present, if at all, in an amount less than 0.01% by weight, based on the total resin solids weight of the composition. As used herein, an electrodepositable coating composition is “essentially free” of any of such materials (each individually) if the material is present, if at all, in trace or incidental amounts insufficient to affect any properties of the composition, such as, e.g., less than 0.001% by weight, based on the total resin solids weight of the composition. As used herein, an electrodepositable coating composition is “completely free” of any of such materials (each individually) if the material is not present in the composition, i.e., 0.000% by weight, based on the total resin solids weight of the composition.

The electrodepositable coating composition may comprise a second addition polymer that is different from the hydroxyl-functional addition polymer.

The second addition polymer may comprise an acrylic polymer comprising a polymerization product of a polymeric dispersant and an aqueous dispersion of a second stage ethylenically unsaturated monomer composition. As used herein, the term “acrylic polymer” refers to a polymerization product at least partially comprising the residue of (meth)acrylic monomers. The polymerization product may be formed by a two-stage polymerization process, wherein the polymeric dispersant is polymerized during the first stage and the second stage ethylenically unsaturated monomer composition is added to an aqueous dispersion of the polymeric dispersant and polymerized in the presence of the polymeric dispersant that participates in the polymerization to form the acrylic polymer during the second stage. A non-limiting example of an acrylic polymer comprising a polymerization product of a polymeric dispersant and an aqueous dispersion of a second stage ethylenically unsaturated monomer composition is described in Int'l Pub. No. WO 2018/160799 A1, at par. [0013] to [0055], the cited portion of which is incorporated herein by reference.

The second addition polymer may alternatively comprise a polymerization product of a polymeric dispersant and a second stage ethylenically unsaturated monomer composition comprising a second stage (meth)acrylamide monomer. A non-limiting example of a polymerization product of a polymeric dispersant and a second stage ethylenically unsaturated monomer composition comprising a second stage (meth)acrylamide monomer is described in PCT Pat. Appln. No. PCT/US2022/070969, at par. [0012] to [0066], the cited portion of which is incorporated herein by reference.

The second addition polymer described above may be present in the electrodepositable coating composition in an amount of at least 0.01% by weight, such as at least 0.1% by weight, such as at least 0.3% by weight, such as at least 0.5% by weight, such as at least 0.75% by weight, such as 1% by weight, based on the total weight of the resin solids of the electrodepositable coating composition. The second addition polymer described above may be present in the electrodepositable coating composition in an amount no more than 5% by weight, such as no more than 3% by weight, such as no more than 2% by weight, such as no more than 1.5% by weight, such as no more than 1% by weight, such as n no more than 0.75% by weight, based on the total weight of the resin solids of the electrodepositable coating composition. The second addition polymer may be present in the electrodepositable coating composition in an amount of 0.01% to 5% by weight, such as 0.01% to 3% by weight, such as 0.01% to 2% by weight, such as 0.01% to 1.5% by weight, such as 0.01% to 1% by weight, such as 0.01% to 0.75% by weight, such as 0.1% to 5% by weight, such as 0.1% to 3% by weight, such as 0.1% to 2% by weight, such as 0.1% to 1.5% by weight, such as 0.1% to 1% by weight, such as 0.1% to 0.75% by weight, such as 0.3% to 5% by weight, such as 0.3% to 3% by weight, such as 0.3% to 2% by weight, such as 0.3% to 1.5% by weight, such as 0.3% to 1% by weight, such as 0.3% to 0.75% by weight, such as 0.5% to 5% by weight, such as 0.5% to 3% by weight, such as 0.5% to 2% by weight, such as 0.5% to 1.5% by weight, such as 0.5% to 1% by weight, such as 0.5% to 0.75% by weight, such as 1% to 5% by weight, such as 1% to 3% by weight, such as 1% to 2% by weight, such as 1% to 1.5% by weight, based on the total weight of the resin solids of the electrodepositable coating composition.

The electrodepositable coating composition may further comprise other optional ingredients, such as, if desired, various additives such as fillers, antioxidants, biocides, UV light absorbers and stabilizers, hindered amine light stabilizers, defoamers, fungicides, dispersing aids, flow control agents, surfactants, wetting agents, crater-control additives, or combinations thereof. Alternatively, the electrodepositable coating composition may be completely free of any of the optional ingredients, i.e., the optional ingredient is not present in the electrodepositable coating composition. The other additives mentioned above may each independently be present in the electrodepositable coating composition in amounts of 0.01% to 3% by weight, based on total weight of the resin solids of the electrodepositable coating composition.

The electrodepositable coating composition may further comprise a plasticizer. The plasticizer may be any suitable plasticizer. The plasticizer may comprise, for example, a polyalkylene glycol, such as polyethylene glycol, polypropylene glycol, or polybutylene glycol. The polyalkylene glycol may comprise two secondary hydroxyl functional groups. The plasticizer may have a molecular weight of at least 400 g/mol, such as at least 500 g/mol, such as at least 700 g/mol. The plasticizer may have a molecular weight of no more 5,000 g/mol, such as no more than 1,000 g/mol, such as no more than 800 g/mol. The plasticizer may have a molecular weight of 400 to 5,000 g/mol, such as 400 to 1,000 g/mol, such as 400 to 800 g/mol, such as 500 to 5,000 g/mol, such as 500 to 1,000 g/mol, such as 500 to 800 g/mol, such as 700 to 5,000 g/mol, such as 700 to 1,000 g/mol, such as 700 to 800 g/mol.

The electrodepositable coating composition may optionally further comprise bis[2-(2-butoxyethoxy)ethoxy]methane. The bis[2-(2-butoxyethoxy)ethoxy]methane may be present in an amount of at least 0.1% by weight, such as at least 0.5% by weight, based on the resin solids weight. The bis[2-(2-butoxyethoxy)ethoxy]methane may be present in an amount of no more than 15% by weight, such as no more than 10% by weight, such as no more than 3% by weight, based on the resin solids weight. The bis[2-(2-butoxyethoxy)ethoxy]methane may be present in an amount of 0.1% to 15% by weight, such as 0.1% to 10% by weight, such as 0.1% to 3% by weight, such as 0.5% to 15% by weight, such as 0.5% to 10% by weight, such as 0.5% to 3% by weight, based on the resin solids weight.

The electrodepositable coating composition may comprise water and/or one or more organic solvent(s). Water can for example be present in amounts of 40% to 90% by weight, such as 50% to 75% by weight, based on total weight of the electrodepositable coating composition. Examples of suitable organic solvents include oxygenated organic solvents, such as monoalkyl ethers of ethylene glycol, diethylene glycol, propylene glycol, and dipropylene glycol which contain from 1 to 10 carbon atoms in the alkyl group, such as the monoethyl and monobutyl ethers of these glycols. Examples of other at least partially water-miscible solvents include alcohols such as ethanol, isopropanol, butanol and diacetone alcohol. If used, the organic solvents may typically be present in an amount of less than 10% by weight, such as less than 5% by weight, based on total weight of the electrodepositable coating composition. The electrodepositable coating composition may in particular be provided in the form of a dispersion, such as an aqueous dispersion.

The total solids content of the electrodepositable coating composition may be at least 1% by weight, such as at least 5% by weight, such as at least 10% by weight, and may be no more than 60% by weight, such as no more than 50% by weight, such as no more than 40% by weight, such as no more than 20% by weight, based on the total weight of the electrodepositable coating composition. The total solids content of the electrodepositable coating composition may be from 1% to 60% by weight, such as 1% to 50% by weight, such as 1% to 40% by weight, such as 1% to 20% by weight, such as 5% to 60% by weight, such as 5% to 50% by weight, such as 5% to 40% by weight, such as 5% to 20% by weight, such as 10% to 60% by weight, such as 10% to 50% by weight, such as 10% to 40% by weight, such as 10% to 20% by weight, based on the total weight of the electrodepositable coating composition. As used herein, “total solids” refers to the non-volatile content of the electrodepositable coating composition, i.e., materials which will not volatilize when heated to 110° C. for 15 minutes.

### Substrates

The electrodepositable coating composition may be electrophoretically applied to a substrate. The cationic electrodepositable coating composition may be electrophoretically deposited upon any electrically conductive substrate. Suitable substrates include metal substrates, metal alloy substrates, and/or substrates that have been metallized, such as nickel-plated plastic. Additionally, substrates may comprise non-metal conductive materials including composite materials such as, for example, materials comprising carbon fibers or conductive carbon. According to the present disclosure, the metal or metal alloy may comprise cold rolled steel, hot rolled steel, steel coated with zinc metal, zinc compounds, or zinc alloys, such as electrogalvanized steel, hot-dipped galvanized steel, galvanealed steel, and steel plated with zinc alloy. Aluminum alloys of the 2XXX, 5XXX, 6XXX, or 7XXX series as well as clad aluminum alloys and cast aluminum alloys of the A356 series also may be used as the substrate. Magnesium alloys of the AZ31B, AZ91C, AM60B, or EV31A series also may be used as the substrate. The substrate used in the present disclosure may also comprise titanium and/or titanium alloys. Other suitable non-ferrous metals include copper and magnesium, as well as alloys of these materials. Suitable metal substrates for use in the present disclosure include those that are often used in the assembly of vehicular bodies (e.g., without limitation, door, body panel, trunk deck lid, roof panel, hood, roof and/or stringers, rivets, landing gear components, and/or skins used on an aircraft), a vehicular frame, vehicular parts, motorcycles, wheels, industrial structures and components such as appliances, including washers, dryers, refrigerators, stoves, dishwashers, and the like, agricultural equipment, lawn and garden equipment, air conditioning units, heat pump units, lawn furniture, and other articles. As used herein, “vehicle” or variations thereof includes, but is not limited to, civilian, commercial and military aircraft, and/or land vehicles such as cars, motorcycles, and/or trucks. The metal substrate also may be in the form of, for example, a sheet of metal or a fabricated part. It will also be understood that the substrate may be pretreated with a pretreatment solution including a zinc phosphate pretreatment solution such as, for example, those described in U.S. Pat. Nos. 4,793,867 and 5,588,989, or a zirconium containing pretreatment solution such as, for example, those described in U.S. Pat. Nos. 7,749,368 and 8,673,091.

In examples, the substrate may comprise a three-dimensional component formed by an additive manufacturing process such as selective laser melting, e-beam melting, directed energy deposition, binder jetting, metal extrusion, and the like. In examples, the three-dimensional component may be a metal and/or resinous component.

### Methods of Coating, Coatings and Coated Substrates

The present disclosure is also directed to methods for coating a substrate, such as any one of the electroconductive substrates mentioned above. According to the present disclosure such method may comprise electrophoretically applying an electrodepositable coating composition as described above to at least a portion of the substrate and curing the coating composition to form an at least partially cured coating on the substrate. According to the present disclosure, the method may comprise (a) electrophoretically depositing onto at least a portion of the substrate an electrodepositable coating composition of the present disclosure and (b) heating the coated substrate to a temperature and for a time sufficient to cure the electrodeposited coating on the substrate. According to the present disclosure, the method may optionally further comprise (c) applying directly to the at least partially cured electrodeposited coating one or more pigment-containing coating compositions and/or one or more pigment-free coating compositions to form a topcoat over at least a portion of the at least partially cured electrodeposited coating, and (d) heating the coated substrate of step (c) to a temperature and for a time sufficient to cure the topcoat.

The cationic electrodepositable coating composition of the present disclosure may be deposited upon an electrically conductive substrate by placing the composition in contact with an electrically conductive cathode and an electrically conductive anode, with the surface to be coated being the cathode. Following contact with the composition, an adherent film of the coating composition is deposited on the cathode when a sufficient voltage is impressed between the electrodes. The conditions under which the electrodeposition is carried out are, in general, similar to those used in electrodeposition of other types of coatings. The applied voltage may be varied and can be, for example, as low as one volt to as high as several thousand volts, such as between 50 and 500 volts. The current density may be between 0.5 ampere and 15 amperes per square foot and tends to decrease during electrodeposition indicating the formation of an insulating film.

Once the cationic electrodepositable coating composition is electrodeposited over at least a portion of the electroconductive substrate, the coated substrate is heated to a temperature and for a time sufficient to at least partially cure the electrodeposited coating on the substrate. As used herein, the term “at least partially cured” with respect to a coating refers to a coating formed by subjecting the coating composition to curing conditions such that a chemical reaction of at least a portion of the reactive groups of the components of the coating composition occurs to form a coating. As discussed above, the electrodepositable coating composition is capable of curing at surprisingly low temperature. The coated substrate may be heated to a temperature ranging from 250° F. to 450° F. (121.1° C. to 232.2° C.), such as from 275° F. to 400° F. (135° C. to 204.4° C.), such as from 284° F. to 360° F. (140° C. to 180° C.), such as less than 302° F. (150° C.), such as less than 284° F. (140° C.). The curing time may be dependent upon the curing temperature as well as other variables, for example, the film thickness of the electrodeposited coating, level and type of catalyst present in the composition and the like. For purposes of the present disclosure, all that is necessary is that the time be sufficient to effect cure of the coating on the substrate. For example, the curing time can range from 10 minutes to 60 minutes, such as 20 to 40 minutes. The thickness of the resultant cured electrodeposited coating may range from 15 to 50 microns.

The anionic electrodepositable coating composition of the present disclosure may be deposited upon an electrically conductive substrate by placing the composition in contact with an electrically conductive cathode and an electrically conductive anode, with the surface to be coated being the anode. Following contact with the composition, an adherent film of the coating composition is deposited on the anode when a sufficient voltage is impressed between the electrodes. The conditions under which the electrodeposition is carried out are, in general, similar to those used in electrodeposition of other types of coatings. The applied voltage may be varied and can be, for example, as low as one volt to as high as several thousand volts, such as between 50 and 500 volts. The current density may be between 0.5 ampere and 15 amperes per square foot and tends to decrease during electrodeposition indicating the formation of an insulating film.

Once the anionic electrodepositable coating composition is electrodeposited over at least a portion of the electroconductive substrate, the coated substrate may be heated to a temperature and for a time sufficient to at least partially cure the electrodeposited coating on the substrate. As used herein, the term “at least partially cured” with respect to a coating refers to a coating formed by subjecting the coating composition to curing conditions such that a chemical reaction of at least a portion of the reactive groups of the components of the coating composition occurs to form a coating. As discussed above, the electrodepositable coating composition is capable of curing at surprisingly low temperature. The coated substrate may be heated to a temperature ranging from 200° F. to 450° F. (93° C. to 232.2° C.), such as from 275° F. to 400° F. (135° C. to 204.4° C.), such as from 284° F. to 360° F. (140° C. to 180° C.), such as less than 302° F. (150° C.), such as less than 284° F. (140° C.). The curing time may be dependent upon the curing temperature as well as other variables, for example, film thickness of the electrodeposited coating, level and type of catalyst present in the composition and the like. For purposes of the present disclosure, all that is necessary is that the time be sufficient to effect cure of the coating on the substrate. For example, the curing time may range from 10 to 60 minutes, such as 20 to 40 minutes. The thickness of the resultant cured electrodeposited coating may range from 15 to 50 microns.

The electrodepositable coating compositions of the present disclosure may also, if desired, be applied to a substrate using non-electrophoretic coating application techniques, such as flow, dip, spray and roll coating applications. For non-electrophoretic coating applications, the coating compositions may be applied to conductive substrates as well as non-conductive substrates such as glass, wood and plastic.

The present disclosure is further directed to a coating formed by at least partially curing the electrodepositable coating composition described herein.

The present disclosure is further directed to a substrate that is coated, at least in part, with the electrodepositable coating composition described herein in an at least partially cured state.

The present disclosure is also directed to a coated substrate having a coating comprising (a) a hydroxyl-functional addition polymer wherein at least 70% of the constitutional units comprise constitutional units according to formula I:

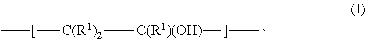

wherein each R¹ is independently one of hydrogen, an alkyl group, a substituted alkyl group, a cycloalkyl group, a substituted cycloalkyl group, an alkylcycloalkyl group, a substituted alkylcycloalkyl group, a cycloalkylalkyl group, a substituted cycloalkylalkyl group, an aryl group, a substituted aryl group, an alkylaryl group, a substituted alkylaryl group, a cycloalkylaryl group, a substituted cycloalkylaryl group, an arylalkyl group, a substituted arylalkyl group, an arylcycloalkyl group, or a substituted arylcycloalkyl group; (b) an ionic salt group-containing film-forming polymer comprising active hydrogen functional groups; (c) a blocked polyisocyanate curing agent comprising blocking groups, wherein the blocking groups comprise a 1,2-polyol as a blocking agent; and (d) a bismuth catalyst. The coating may optionally further comprise a pigment.

The present disclosure is also directed to a coated substrate having a coating comprising (a) an ionic salt group-containing film-forming polymer comprising active hydrogen functional groups, wherein the ionic salt group-containing film-forming polymer comprises a reaction product of a reaction mixture comprising: (i) a polyepoxide; (ii) a polyphenol; and (iii) a mono-functional reactant; (b) a blocked polyisocyanate curing agent comprising blocking groups, wherein the blocking groups comprise a 1,2-polyol as a blocking agent; (c) a bismuth catalyst. The coating may optionally further comprise a pigment.

The present disclosure is also directed to a coated substrate having a coating comprising (a) a hydroxyl-functional addition polymer wherein at least 70% of the constitutional units comprise constitutional units according to formula I:

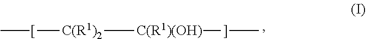

wherein each R¹ is independently one of hydrogen, an alkyl group, a substituted alkyl group, a cycloalkyl group, a substituted cycloalkyl group, an alkylcycloalkyl group, a substituted alkylcycloalkyl group, a cycloalkylalkyl group, a substituted cycloalkylalkyl group, an aryl group, a substituted aryl group, an alkylaryl group, a substituted alkylaryl group, a cycloalkylaryl group, a substituted cycloalkylaryl group, an arylalkyl group, a substituted arylalkyl group, an arylcycloalkyl group, or a substituted arylcycloalkyl group; (b) an ionic salt group-containing film-forming polymer comprising active hydrogen functional groups; (c) a blocked polyisocyanate curing agent comprising blocking groups, wherein the blocking groups comprise a 1,2-polyol as a blocking agent; (d) a bismuth catalyst; and (e) at least one pigment.

The present disclosure is also directed to a coated substrate having a coating comprising (a) a hydroxyl-functional addition polymer wherein at least 70% of the constitutional units comprise constitutional units according to formula I:

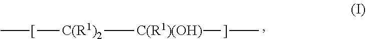

wherein each R¹ is independently one of hydrogen, an alkyl group, a substituted alkyl group, a cycloalkyl group, a substituted cycloalkyl group, an alkylcycloalkyl group, a substituted alkylcycloalkyl group, a cycloalkylalkyl group, a substituted cycloalkylalkyl group, an aryl group, a substituted aryl group, an alkylaryl group, a substituted alkylaryl group, a cycloalkylaryl group, a substituted cycloalkylaryl group, an arylalkyl group, a substituted arylalkyl group, an arylcycloalkyl group, or a substituted arylcycloalkyl group; (b) an ionic salt group-containing film-forming polymer comprising active hydrogen functional groups, wherein the ionic salt group-containing film-forming polymer comprises a reaction product of a reaction mixture comprising: (i) a polyepoxide; (ii) a polyphenol; and (iii) a mono-functional reactant; (c) a blocked polyisocyanate curing agent comprising blocking groups, wherein the blocking groups comprise a 1,2-polyol as a blocking agent; and (d) a bismuth catalyst. The coating may optionally further comprise a pigment.

### Multi-Layer Coating Composites

The electrodepositable coating compositions of the present disclosure may be utilized in an electrocoating layer that is part of a multi-layer coating composite comprising a substrate with various coating layers. The coating layers may include a pretreatment layer, such as a phosphate layer (e.g., zinc phosphate layer), an electrocoating layer which results from the electrodepositable coating composition of the present disclosure, and suitable topcoat layers (e.g., base coat, clear coat layer, pigmented monocoat, and color-plus-clear composite compositions). It is understood that suitable topcoat layers include any of those known in the art, and each independently may be waterborne, solventborne, in solid particulate form (i.e., a powder coating composition), or in the form of a powder slurry. The topcoat typically includes a film-forming polymer, crosslinking material and, if a colored base coat or monocoat, one or more pigments. According to the present disclosure, the primer layer may be disposed between the electrocoating layer and the base coat layer. According to the present disclosure, one or more of the topcoat layers are applied onto a substantially uncured underlying layer. For example, a clear coat layer may be applied onto at least a portion of a substantially uncured basecoat layer (wet-on-wet), and both layers may be simultaneously cured in a downstream process.

Moreover, the top-coat layers may be applied directly onto the electrodepositable coating layer. In other words, the substrate lacks a primer layer. For example, a basecoat layer may be applied directly onto at least a portion of the electrodepositable coating layer.

It will also be understood that the top-coat layers may be applied onto an underlying layer despite the fact that the underlying layer has not been fully cured. For example, a clearcoat layer may be applied onto a basecoat layer even though the basecoat layer has not been subjected to a curing step. Both layers may then be cured during a subsequent curing step thereby eliminating the need to cure the basecoat layer and the clearcoat layer separately.

According to the present disclosure, additional ingredients such as colorants and fillers may be present in the various coating compositions from which the top-coat layers result. Any suitable colorants and fillers may be used. For example, the colorant may be added to the coating in any suitable form, such as discrete particles, dispersions, solutions and/or flakes. A single colorant or a mixture of two or more colorants can be used in the coatings of the present disclosure. It should be noted that, in general, the colorant can be present in a layer of the multi-layer composite in any amount sufficient to impart the desired property, visual and/or color effect.

Example colorants include pigments, dyes and tints, such as those used in the paint industry and/or listed in the Dry Color Manufacturers Association (DCMA), as well as special effect compositions. A colorant may include, for example, a finely divided solid powder that is insoluble but wettable under the conditions of use. A colorant may be organic or inorganic and may be agglomerated or non-agglomerated. Colorants may be incorporated into the coatings by grinding or simple mixing. Colorants may be incorporated by grinding into the coating by use of a grind vehicle, such as an acrylic grind vehicle, the use of which will be familiar to one skilled in the art.

Example pigments and/or pigment compositions include, but are not limited to, carbazole dioxazine crude pigment, azo, monoazo, disazo, naphthol AS, salt type (lakes), benzimidazolone, condensation, metal complex, isoindolinone, isoindoline and polycyclic phthalocyanine, quinacridone, perylene, perinone, diketopyrrolo pyrrole, thioindigo, anthraquinone, indanthrone, anthrapyrimidine, flavanthrone, pyranthrone, anthanthrone, dioxazine, triarylcarbonium, quinophthalone pigments, diketo pyrrolo pyrrole red (“DPP red BO”), titanium dioxide, carbon black, zinc oxide, antimony oxide, etc. and organic or inorganic UV opacifying pigments such as iron oxide, transparent red or yellow iron oxide, phthalocyanine blue and mixtures thereof. The terms “pigment” and “colored filler” can be used interchangeably.

Example dyes include, but are not limited to, those that are solvent and/or aqueous based such as acid dyes, azoic dyes, basic dyes, direct dyes, disperse dyes, reactive dyes, solvent dyes, sulfur dyes, mordant dyes, for example, bismuth vanadate, anthraquinone, perylene, aluminum, quinacridone, thiazole, thiazine, azo, indigoid, nitro, nitroso, oxazine, phthalocyanine, quinoline, stilbene, and triphenyl methane.

Example tints include, but are not limited to, pigments dispersed in water-based or water miscible carriers such as AQUA-CHEM 896 commercially available from Degussa, Inc., CHARISMA COLORANTS and MAXITONER INDUSTRIAL COLORANTS commercially available from Accurate Dispersions division of Eastman Chemical, Inc.

The colorant may be in the form of a dispersion including, but not limited to, a nanoparticle dispersion. Nanoparticle dispersions can include one or more highly dispersed nanoparticle colorants and/or colorant particles that produce a desired visible color and/or opacity and/or visual effect. Nanoparticle dispersions may include colorants such as pigments or dyes having a particle size of less than 150 nm, such as less than 70 nm, or less than 30 nm. Nanoparticles may be produced by milling stock organic or inorganic pigments with grinding media having a particle size of less than 0.5 mm. Example nanoparticle dispersions and methods for making them are identified in U.S. Pat. No. 6,875,800 B2, which is incorporated herein by reference. Nanoparticle dispersions may also be produced by crystallization, precipitation, gas phase condensation, and chemical attrition (i.e., partial dissolution). In order to minimize re-agglomeration of nanoparticles within the coating, a dispersion of resin-coated nanoparticles may be used. As used herein, a “dispersion of resin-coated nanoparticles” refers to a continuous phase in which is dispersed discreet “composite microparticles” that comprise a nanoparticle and a resin coating on the nanoparticle. Example dispersions of resin-coated nanoparticles and methods for making them are identified in U.S. patent application Ser. No. 10/876,031 filed Jun. 24, 2004, which is incorporated herein by reference, and U.S. Provisional Patent Application No. 60/482,167 filed Jun. 24, 2003, which is also incorporated herein by reference.

According to the present disclosure, special effect compositions that may be used in one or more layers of the multi-layer coating composite include pigments and/or compositions that produce one or more appearance effects such as reflectance, pearlescence, metallic sheen, phosphorescence, fluorescence, photochromism, photosensitivity, thermochromism, goniochromism and/or color-change. Additional special effect compositions may provide other perceptible properties, such as reflectivity, opacity or texture. For example, special effect compositions may produce a color shift, such that the color of the coating changes when the coating is viewed at different angles. Example color effect compositions are identified in U.S. Pat. No. 6,894,086, incorporated herein by reference. Additional color effect compositions may include transparent coated mica and/or synthetic mica, coated silica, coated alumina, a transparent liquid crystal pigment, a liquid crystal coating, and/or any composition wherein interference results from a refractive index differential within the material and not because of the refractive index differential between the surface of the material and the air.

According to the present disclosure, a photosensitive composition and/or photochromic composition, which reversibly alters its color when exposed to one or more light sources, can be used in a number of layers in the multi-layer composite. Photochromic and/or photosensitive compositions can be activated by exposure to radiation of a specified wavelength. When the composition becomes excited, the molecular structure is changed, and the altered structure exhibits a new color that is different from the original color of the composition. When the exposure to radiation is removed, the photochromic and/or photosensitive composition can return to a state of rest, in which the original color of the composition returns. For example, the photochromic and/or photosensitive composition may be colorless in a non-excited state and exhibit a color in an excited state. Full color-change may appear within milliseconds to several minutes, such as from 20 seconds to 60 seconds. Example photochromic and/or photosensitive compositions include photochromic dyes.

According to the present disclosure, the photosensitive composition and/or photochromic composition may be associated with and/or at least partially bound to, such as by covalent bonding, a polymer and/or polymeric materials of a polymerizable component. In contrast to some coatings in which the photosensitive composition may migrate out of the coating and crystallize into the substrate, the photosensitive composition and/or photochromic composition associated with and/or at least partially bound to a polymer and/or polymerizable component in accordance with the present disclosure, have minimal migration out of the coating. Example photosensitive compositions and/or photochromic compositions and methods for making them are identified in U.S. patent application Ser. No. 10/892,919 filed Jul. 16, 2004 and incorporated herein by reference.

As used herein, the term “resin solids” include the ionic salt group-containing film-forming polymer, the blocked polyisocyanate curing agent, and any additional water-dispersible non-pigmented component(s) present in the electrodepositable coating composition.

As used herein, the term “polymer” encompasses, but is not limited to, oligomers and both homopolymers and copolymers.

As used herein, unless otherwise defined, the term substantially free means that the component is present, if at all, in an amount of less than 5% by weight, based on the total weight of the slurry composition.

As used herein, unless otherwise defined, the term essentially free means that the component is present, if at all, in an amount of less than 1% by weight, based on the total weight of the slurry composition.

As used herein, unless otherwise defined, the term completely free means that the component is not present in the slurry composition, i.e., 0.00% by weight, based on the total weight of the slurry composition.

For purposes of this detailed description, it is to be understood that the disclosure may assume alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present disclosure. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

As used herein, “including,” “containing” and like terms are understood in the context of this application to be synonymous with “comprising” and are therefore open-ended and do not exclude the presence of additional undescribed or unrecited elements, materials, ingredients or method steps. As used herein, “consisting of” is understood in the context of this application to exclude the presence of any unspecified element, ingredient or method step. As used herein, “consisting essentially of” is understood in the context of this application to include the specified elements, materials, ingredients or method steps “and those that do not materially affect the basic and novel characteristic(s)” of what is being described.

In this application, the use of the singular includes the plural and plural encompasses singular, unless specifically stated otherwise. For example, although reference is made herein to “a” hydroxyl-functional addition polymer, “an” ionic salt group-containing film-forming polymer, “a” blocked polyisocyanate curing agent, and/or “a” bismuth catalyst, a combination (i.e., a plurality) of these components may be used. In addition, in this application, the use of “or” means “and/or” unless specifically stated otherwise, even though “and/or” may be explicitly used in certain instances.

Whereas specific aspects of the disclosure have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the disclosure which is to be given the full breadth of the claims appended and any and all equivalents thereof.

Illustrating the disclosure are the following examples, which, however, are not to be considered as limiting the disclosure to their details. Unless otherwise indicated, all parts and percentages in the following examples, as well as throughout the specification, are by weight.

### EXAMPLES

### Example 1: Preparation of Blocked Polyisocyanate Curing Agent

A blocked polyisocyanate curing agent was prepared in the following manner: Components 2-5 listed in Table 1, below, were mixed in a flask set up for total reflux with stirring under nitrogen. The mixture was heated to a temperature of 30° C., and Component 1 was added dropwise so that the temperature increased due to the reaction exotherm and was maintained under 100° C. After the addition of Component 1 was complete, Component 6 was added to the mixture. A temperature of 100° C. was then established and the reaction mixture was held at temperature until no residual isocyanate was detected by IR spectroscopy. Component 7 was then added, and the reaction mixture was allowed to stir for 30 minutes before cooling to ambient temperature. This crosslinker is referred to as Crosslinker I below.

TABLE 1

| No. | Component | Parts |
|---|---|---|
| 1 | Polymeric methylene diphenyl diisocyanate¹ | 1560.9 |
| 2 | Dibutyltin dilaurate | 1.4 |
| 3 | Methyl isobutyl ketone | 445.5 |
| 4 | Propylene glycol | 619.7 |
| 5 | (2-(2-Butoxyethoxy)ethanol) | 566.1 |
| 6 | Bis[2-(2-butoxyethoxy)ethoxy]methane² | 56.9 |
| 7 | Methyl isobutyl ketone | 49.5 |

¹Rubinate M, available from Huntsman Corporation.
²Available as Mazon 1651 from BASF Corporation

### Example 2: Preparation of a Cationic, Amine-Functionalized, Polyepoxide-Based Resin

A cationic, amine-functionalized, polyepoxide-based polymeric resin was prepared in the following manner. Components 1-6 listed in Table 2, below, were mixed in a flask set up for total reflux with stirring under nitrogen. The mixture was heated to a temperature of 130° C. and allowed to exotherm (175° C. maximum). A temperature of 145° C. was established in the reaction mixture and the reaction mixture was then held for 2 hours. Component 7 was introduced slowly while allowing the mixture to cool to 125° C. followed by the addition of Component 8. A temperature of 105° C. was established, and Components 9 and 10 were then added to the reaction mixture quickly (sequential addition) and the reaction mixture was allowed to exotherm. A temperature of 115° C. was established and the reaction mixture held for 1 hour, resulting in Resin Synthesis Products A-B.

A portion of the Resin Synthesis Product A-B (Component 11) was then poured into a pre-mixed solution of Components 12 and 13 to form a resin dispersion, and the resin dispersion was stirred for 30 min. Component 14 was then introduced over 30 minutes to dilute further the resin dispersion, followed by the addition of Component 15. The free MIBK in the resin dispersion was removed from the dispersion under vacuum at a temperature of 60-70° C.

The solids content of the resulting cationic, amine-functionalized, polyepoxide-based polymeric resin dispersion was determined by adding a quantity of the resin dispersion to a tared aluminum dish, recording the initial weight of the resin dispersion, heating the resin dispersion in the dish for 60 minutes at 110° C. in an oven, allowing the dish to cool to ambient temperature, reweighing the dish to determine the amount of non-volatile content remaining, and calculating the solids content by dividing the weight of the remaining non-volatile content by the initial resin dispersion weight and multiplying by 100. (Note, this procedure was used to determine the solids content in each of resin dispersion examples described below). The solids contents of Resin Dispersions A-B are reported in Table 2.

TABLE 2

| | | Resin Example: | |
|---|---|---|---|
| | | A³ | B⁴ |
| | | Resin Synthesis Stage - | |
| # | Material | Parts by Weight | |
| 1 | EPON 828¹ | 2210.6 | 928.4 |
| 2 | Bisphenol A | 760.5 | 400.5 |
| 3 | Bisphenol A - ethylene oxide adduct (1/6 molar ratio | 955.6 | 404.6 |
| | BPA/EO) | | |
| 4 | Phenol | 163.3 | — |
| 5 | Methyl isobutyl ketone (MIBK) | 126.5 | 53.6 |
| 6 | Ethyl triphenyl phosphonium bromide | 3.5 | 1.5 |
| 7 | Methyl isobutyl ketone | 28.1 | 11.7 |
| 8 | Crosslinker I | 3166.0 | 1344.2 |
| 9 | Diethylene triamine - MIBK diketimine ² | 203.0 | 86.6 |
| 10 | N-Methyl ethanolamine | 173.4 | 73.1 |
| 11 | Resin Synthesis Product | 7011.4 | 2967.4 |
| 12 | Formic Acid (90% in water) | 98.1 | 41.5 |
| 13 | DI Water | 2734.4 | 1158.2 |
| 14 | DI Water | 6152.4 | 2606.0 |
| 15 | DI Water | 3199.3 | 1355.0 |

¹Diglycidyl ether of Bisphenol A with an epoxy equivalent weight of 186-190.
² 72.7% by weight (in MIBK) of the diketimine reaction product of 1 equivalent of diethylene triamine and 2 equivalents of MIBK.
³Multiple batches A was made. Their resin solids varied and are further indicated by specific batch: Resin A1 39.54% by weight; A2 = 40.56% by weight.
⁴Multiple batches B was made. Their resin solids varied and are further indicated by specific batch: Resin B1 = 39.83% by weight; B2 = 37.63% by weight.

### Example 3: Preparation of Hydroxyl-Functional Addition Polymer (Polyvinyl Alcohol) Solution

Component 1 was added to a 1 L glass jar. The liquid was agitated while component 2 was added over 30 minutes with one quarter of the material added every 5 minutes. After stirring for 1-3 hours, mixing was stopped, and the solution was heated to 71PC for 16 hours. The solution was then cooled to room temperature.

TABLE 3

| # | Material | EA 1 | EA 2 | EA 3 | EA 4 | EA 5 |
|---|---|---|---|---|---|---|
| 1 | DI Water | 500 | 500 | 500 | 500 | 500 |
| 2 | Hydroxyl-functional addition | 50 | — | — | — | — |
| | polymer 1¹ | | | | | |
| | Hydroxyl-functional addition | — | 50 | — | — | — |
| | polymer 2² | | | | | |
| | Hydroxyl-functional addition | — | — | 50 | — | — |
| | polymer 3³ | | | | | |
| | Hydroxyl-functional addition | — | — | — | 50 | — |
| | polymer 4⁴ | | | | | |
| | Hydroxyl-functional addition | — | — | — | — | 50 |
| | polymer 5⁵ | | | | | |

¹Polyvinyl alcohol polymer having a reported weight average molecular weight of 146,000 to 186,000 g/mol, a reported number average molecular weight of 70,000 to 101,000 g/mol, a reported hydrolysis amount of 88%, and a reported viscosity of 50 ± 5 cP for a 4% by weight aqueous solution at 20° C. measured using a Brookfield synchronized-motor rotary type viscometer, commercially available from Sekisui Specialty Chemicals America, LLC. as SELVOL ™ 540.
²Polyvinyl alcohol polymer having a reported weight average molecular weight of 61,600 g/mol, a reported hydrolysis amount of 88%, and a reported viscosity of 3.8 to 4.4 cP for a 4% by weight aqueous solution at 20° C. measured using a Brookfield synchronized-motor rotary type viscometer, commercially available as Kuraray POVAL ™ 4-88 from Kuraray
³Polyvinyl alcohol polymer having a reported weight average molecular weight of 86,000 g/mol, a reported hydrolysis amount of 74%, and a reported viscosity of 3.6 to 4.2 cP for a 4% by weight aqueous solution at 20° C. measured using a Brookfield synchronized-motor rotary type viscometer, commercially available as Kuraray POVAL ™ 5-74 from Kuraray
⁴Polyvinyl alcohol polymer having a reported weight average molecular weight of 214,500 g/mol, a reported hydrolysis amount of 88%, and a reported viscosity of 20.5 to 24.5 cP for a 4% by weight aqueous solution at 20° C. measured using a Brookfield synchronized-motor rotary type viscometer, commercially available as Kuraray POVAL ™ 22-88 from Kuraray
⁵Polyvinyl alcohol polymer having a reported weight average molecular weight of 310,800 g/mol, a reported hydrolysis amount of 88%, and a reported viscosity of 90.0 to 120.0 cP for a 4% by weight aqueous solution at 20° C. measured using a Brookfield synchronized-motor rotary type viscometer, commercially available as Kuraray POVAL ™ 100-88 from Kuraray

### Example 4: Preparation of Catalyst Solution

An aqueous bismuth methane sulfonate catalyst solution was prepared using the ingredients from Table 4 in the following manner: Component 1 was added to an Erlenmeyer flask with stirring, followed by the sequential introduction of Components 2 and 3. The content of the flask was stirred for 3 hours at room temperature, and the resulting catalyst solution was then filtered through a Buchner funnel to remove any undissolved residue.

TABLE 4

| # | Material | Parts |
|---|---|---|
| 1 | Deionized water | 2109.7 |
| 2 | Methanesulfonic acid¹ | 191.9 |
| 3 | Bismuth(III) oxide² | 288.8 |

¹70% solution in deionized water.
²5N Plus Frit grade.

### Example 5: Preparation of Grind Vehicle

This example describes the preparation of a quaternary ammonium salt containing pigment-grinding resin. Example 5-1 describes the preparation of an amine-acid salt quaternizing agent and Example 5-2 describes the preparation of an epoxy group-containing polymer that is subsequently quaternized with the amine-acid salt of Example 5-1.

Examples 5-1: The amine-acid salt quaternizing agent was prepared using the following procedure:

TABLE 5A

| # | Material | Parts |
|---|---|---|
| 1 | Dimethyl ethanolamine | 445.0 |
| 2 | PAPI 290¹ | 661.1 |
| 3 | bis[2-(2-butoxyethoxy)ethoxy]methane ² | 22.1 |
| 4 | 88% lactic acid aqueous | 511.4 |
| 5 | Deionized water | 1026.4 |

¹Polymeric diisocyanate commercially available from Dow Chemical Co.
² Available as Mazon 1651 from BASF Corporation

To a suitably equipped, four-neck flask, Component 1 was charged. Component 2 was then added over a 1.5 hr period, keeping the reaction temperature ≤100° C., followed by addition of Component 3. The resulting mixture was mixed at 90-95° C. until reaction of the isocyanate was complete, as determined by infrared spectroscopy, −1 hr. Components 4 and 5 were pre-mixed and added over 1 hr. A temperature of 85° C. was then established, and the mixture was held at this temperature for 3 hr to yield the amine-acid salt quaternizing agent.

Example 5-2: The quaternary ammonium salt group-containing polymer was prepared using the following procedure:

TABLE 5B

| # | Material | Parts |
|---|---|---|
| 1 | EPON 828¹ | 568.2 |
| 2 | Bisphenol A | 241.9 |
| 3 | Bisphenol A - ethylene oxide adduct (1/6 | 90.0 |
| | molar ratio BPA/EO) | |
| 4 | Bis[2-(2-butoxyethoxy)ethoxy]methane² | 9.9 |
| 5 | Ethyltriphenylphosphonium iodide | 0.5 |
| 6 | Bis[2-(2-butoxyethoxy)ethoxy]methane ² | 142.9 |
| 7 | Bisphenol A diglycidyl ether¹ | 10.5 |
| 8 | Bis[2-(2-butoxyethoxy)ethoxy]methane ² | 9.0 |
| 9 | Amine-acid quaternizing agent, Example 5-1 | 314.9 |
| 10 | Deionized water | 1731.9 |

¹Diglycidyl ether of Bisphenol A with an epoxy equivalent weight of 186-190.
²Available as Mazon 1651 from BASF Corporation.

Components 1-5 were charged to a four-neck flask equipped with stirrer and reflux condenser. The reaction mixture was heated to about 140° C., then allowed to exotherm to about 180° C. A temperature of 160° C. was subsequently established, and the mixture was held at that temperature for 1 hr to achieve an epoxy equivalent weight of 900-1100 g/equiv. Component 6 was charged, and a temperature of 120° C. was established. Components 7-8 were then added, and the mixture was held at 120° C. for 1 hr. The temperature was subsequently lowered to 90° C. Components 9-10 were pre-mixed and then added over 1.5 hr. The reaction temperature was held at about 80° C. for approximately 6 hours until the acid number of the reaction product fell below 1.0, as measured using a Metrohm 799 MPT Titrino automatic titrator utilizing a 0.1 M potassium hydroxide solution in methanol.

### Example 6: Preparation of the Pigment Paste

The catalyst free pigment dispersion was prepared by sequentially adding ingredients 1-5 listed below under high shear agitation. When the ingredients were thoroughly blended, the pigment dispersion was transferred to a vertical sand mill and ground to a Hegman value of >7.5.

TABLE 6

| # | Material | Paste 1¹ |
|---|---|---|
| 1 | Grind Vehicle of Ex. 5 | 1875.00 |
| 2 | N-butoxypropanol | 75.32 |
| 3 | Printex 200² | 28.13 |
| 4 | Titanium Dioxide³ | 2221.88 |
| 5 | Deionized water | 799.68 |

¹Paste 1 was made up two separate times having a slightly different solids content and used to produce a composition having the indicated pigment-to-binder ratio below.
²Carbon Black pigment suppled from Orion Engineered Carbon
³Pigment grade from The Chemours Company

### Example 7: Preparation of Electrodepositable Coating Compositions

For each paint composition described in Tables 7-9, charges 1-5 were added sequentially into a plastic container at room temperature under agitation with 10 minutes of stirring after each addition. The mixture was stirred for at least 30 minutes at room temperature. Charge 6 was then added, and the paint was allowed to stir until uniform, a minimum of 30 minutes. Charge 7 was added, and the paint was allowed to stir for a minimum of 30 minutes until uniform. The resulting cationic electrodepositable paint compositions had a solids content of 25%, determined as by described previously, and a pigment to binder ratio of 0.13/1.0 by weight. After 20% ultrafiltration (and reconstitution with deionized water), coated panels were prepared from a bath containing the cationic electrodepositable coating composition as described below.

TABLE 7

| Charge | Material | A | B | Comp. C |
|---|---|---|---|---|
| 1 | Resin A1 | 1133.02 | — | 1138.89 |
| | Resin B1 | — | 1153.79 | — |
| 2 | Bis[2-(2-butoxyethoxy)ethoxy]methane ¹ | 57.16 | 14.29 | 14.29 |
| 3 | EA 1 | 23.81 | 23.81 | — |
| 4 | Catalyst Solution (Bi-MSA) | 47.62 | 47.62 | 47.62 |
| 5 | DI Water | 104.10 | 83.33 | 122.04 |
| 6 | Paste 1 | 135.00 | 135.00 | 135.00 |
| 7 | Water | 792.10 | 792.10 | 792.10 |

¹ Available from BASF of Florham Park, NJ as Mazon 1651.

TABLE 8

| Charge | Material | D | E | F | G |
|---|---|---|---|---|---|
| 1 | Resin A1 | 1162.25 | — | — | — |
| | Resin A2 | — | 1133.02 | 1133.02 | 1133.02 |
| 2 | Bis[2-(2- | 14.29 | 14.29 | 14.29 | 14.29 |
| | butoxyethoxy)ethoxy]methane ¹ | | | | |
| 3 | EA 2 | 23.81 | — | — | — |
| | EA 3 | — | 23.81 | — | — |
| | EA 4 | — | — | 23.81 | — |
| | EA 5 | — | — | — | 23.81 |
| 4 | Catalyst Solution (Bi-MSA) | 47.62 | 47.62 | 47.62 | 47.62 |
| 5 | DI Water | 74.87 | 104.1 | 104.1 | 104.1 |
| 6 | Paste 1 | 134.5 | 134.5 | 134.5 | 134.5 |
| 7 | Water | 792.7 | 792.1 | 792.7 | 792.7 |

¹ Available from BASF of Florham Park, NJ as Mazon 1651.

TABLE 9

| Charge | Material | H |
|---|---|---|
| 1 | Resin B2 | 1221.24 |
| 2 | Bis[2-(2-butoxyethoxy)ethoxy]methane¹ | 14.29 |
| 3 | EA 1 | 23.81 |
| 4 | Catalyst (Bi-MSA) | 47.62 |
| 5 | Yttrium solution² | 1.90 |
| | DI Water | 15.87 |
| 6 | Paste 1 | 134.5 |
| 7 | Water | 790.80 |

¹Available from BASF of Florham Park, NJ as Mazon 1651.
²Yttrium dissolved in methane sulfonic acid providing 400 ppm yttrium on resin solids.

### Evaluation of Electrodepositable Coating Compositions

The paints were evaluated in accordance with the SURFACE ROUGHNESS TEST METHOD, the EDGE COVERAGE TEST METHOD, the GEL POINT METHOD, and the SMOOTHING TEST METHOD.

Surface Roughness (Appearance): Surface roughness may be evaluated in accordance with the SURFACE ROUGHNESS TEST METHOD by the following method: The electrodepositable coating composition is electrodeposited onto a metal panel and cured, and then coating texture is evaluated using a profilometer over a specified length of the panel, filtering the roughness profile according to ISO 4287-1997 3.1.6 using an Lc parameter of 2.5 mm and an Ls parameter of 8 μm before summarizing an Ra metric according to ISO 4287-1997 4.2.1, hereinafter referred to as Ra. A specific test procedure may be performed as follows: The electrodepositable coating composition may be electrodeposited coated on to cold-rolled steel (CRS) panels that are 4×6×0.032 inches and pretreated with CHEMFOS C700/DI (CHEMFOS C700 is a zinc phosphate immersion pretreatment composition available from PPG Industries, Inc.). These panels are available from ACT Laboratories of Hillside, Mich. The above described electrodepositable paint compositions were electrodeposited onto these specially prepared panels in a manner well known in the art by immersing them into a stirring bath at a temperature between 32.2° C. to 37.2° C. and connecting the cathode of the direct current rectifier to the panel and connecting the anode of the direct current rectifier to the stainless-steel tubing used to circulate cooling water for bath temperature control. The voltage was increased from 0 to a set point voltage of 190V over a period of 30 seconds and then held at that voltage until the desired film thickness was achieved. This combination of time, temperature and voltage deposited a coating that when cured had a dry film thickness of 16-20 microns. Three panels were electrocoated for each paint composition. After electrodeposition, the panels were removed from the bath, rinsed vigorously with a spray of deionized water and cured by baking for 20 minutes at 150° C. in an electric oven (Despatch Industries, model LFD-series).

Coated panel texture may be evaluated using a Mitutoyo Surftest SJ-402 skidded stylus profilometer equipped with a 0.75 mN detector and a diamond stylus tip with a 600 cone and a 2 μm tip radius. The scan force is less than 400 mN. The scan length, measuring speed, and data-sampling interval were 15 mm, 0.5 mm/s, and 1.5 μm, respectively. The raw data was first filtered to a roughness profile according to ISO 4287-1997 3.1.6 using an Lc parameter of 2.5 mm and an Ls parameter of 8 μm before summarizing an Ra metric according to ISO 4287-1997 4.2.1, hereinafter referred to as Ra (2.5 mm).

Edge Coverage Evaluation: Edge coverage may be evaluated in accordance with the EDGE COVERAGE TEST METHOD by the following method: Test panels were specially prepared from cold rolled steel panels, 4×12×0.032 inches, pretreated with CHEMFOS C700/DI and available from ACT Laboratories of Hillside, Michigan. The 4×12×0.3 2-inch panels were first cut into two 4×5¾-inch panels using a Di-Acro Hand Shear No. 24 (DiAcro, Oak Park Heights, Minnesota). The panels are positioned in the cutter so that the burr edge from the cut along the 4-inch edge ends up on the opposite side from the top surface of the panel. Each 4×5-¾ panel is then positioned in the cutter to remove ¼ of an inch from one of the 5¾-inch sides of the panel in such a manner that the burr resulting from the cut faces upward from the top surface of the panel.

The above described electrodepositable paint compositions were then electrodeposited onto these specially prepared panels in a manner well known in the art by immersing them into a stirring bath at 32.2° C. to 37.2° C. and connecting the cathode of the direct current rectifier to the panel and connecting the anode of the direct current rectifier to the stainless-steel tubing used to circulate cooling water for bath temperature control. The voltage was increased from 0 to a set point voltage of 190V over a period of 30 seconds and then held at that voltage until the desired film thickness was achieved. This combination of time, temperature and voltage deposited a coating that when cured had a dry film thickness of 16-20 microns. Two panels were electrocoated for each paint composition. After electrodeposition, the panels were removed from the bath, rinsed vigorously with a spray of deionized water and cured by baking for 20 minutes at 150° C. in an electric oven.

A Di-Acro panel cutter (model number 12 SHEAR) was used to cut out square pieces, approximately 0.5 in ×0.5 in, from the burr edge of the panel. The burr edges are placed within epoxy cups, ten burrs per epoxy mount. This is done using Ted Pella plastic multi clips. Leco Epoxy (811-563-101) and Leco Hardener (812-518) are mixed together using a 100:14 ratio and poured into the mounting cups where the burr samples were placed. The epoxy is allowed to cure overnight. The epoxy mounts are then grinded and polished using a Buehler AutoMet 250. 240 Grit paper is used first, 2 minutes and 30 seconds. 320 grit paper is used next, 2 minutes. 600 grit paper follows, 1 minute. Samples are then polished for 3 minutes and 30 seconds using a 9 micron paste then for 3 minutes using a 3-micron paste. Once polished, the samples are coated for 20 seconds with Au/Pd using an EMS Quorum EMS150TES Sputter coater and placed on aluminum mounts with carbon tape. The coating thickness on the burr was evaluated and compared to the flat area coating thickness.

Gel Point Evaluation: The gel point may be evaluated in accordance with the GEL POINT TEST METHOD by the following method: The electrodepositable coating composition is coated onto 4″×12″0.025″ Aluminum Q panel available Q-Labs of Westlake, OH, until reaching a target film of 0.7-0.9 mils (17-23 microns). The applied, uncured coating is then dissolved in THF and deposited on to a type P-PTD200/56 platen and placed into an Anton Paar rheometer (a 302 model) using an Anton Paar PPR 25/23 spindle and settings of constant 5% shear strain and constant 1 Hz frequency. The temperature is held at 40° C. for 30 min then ramped from 40° C. to 175° C. at a rate of 3.3° C./min. The complex viscosity (cps, 1*), shear strain (%, γ), loss factor (G″/G′), loss modulus (Pa, G″), storage modulus (Pa, G′), and shear stress (Pa, τ) are measured over the temperature ramp, and the gel point is determined to be the point at which loss modulus (G″) crosses the storage modulus (G′).

% Smoothing: The % smoothing may be evaluated in accordance with the SMOOTHING TEST METHOD by the following method: Cold-rolled steel (CRS) panels available from ACT Laboratories of Hillside, Mich. that are 4×6×0.031 inches and pretreated with CHEMFOS C700/DI (CHEMFOS C700 is a zinc phosphate immersion pretreatment composition available from PPG Industries, Inc.) are used for these evaluations. These substrates typically have an Ra (2.5 mm) of 0.6. The surface roughness of an uncoated panel is evaluated using a Mitutoyo Surftest SJ-402 skidless stylus profilometer equipped with a 4 mN detector and a diamond stylus tip with a 900 cone and a 5 μm tip radius. The scan length, measuring speed, and data-sampling interval are 48 mm, 1 mm/s, and 5 μm, respectively. The sampling data is then transferred to a personal computer by use of a USB port located on the profilometer, and the raw data is first filtered to a roughness profile according to ISO 4287-1997 3.1.6 using an Lc parameter of 2.5 mm and an Ls parameter of 8 μm before summarizing an Ra metric according to ISO 4287-1997 4.2.1, hereinafter referred to as Ra (2.5 mm).

The results of the testing areas provided in the tables below.

TABLE 10

| | Mono- | | | | | | |
|---|---|---|---|---|---|---|---|
| | func. | | | Ra | | | |
| Paint | reactant | CAT | EA | (2.5 mm) | Smooth | Burr | GP |
| A | Phenol | Bi-MSA | EA 1 | 0.450 | 25% | 24% | 138 |
| B | None | Bi-MSA | EA 1 | 0.873 | −46% | 28% | 127 |
| Comp. C | Phenol | Bi-MSA | None | 0.159 | 74% | 2% | 137 |
| H | None | Bi-MSA | EA 1 | 0.620 | −3% | 19% | 136 |

The results in the table above demonstrate that the use of a mono-functional reactant in making the electrodepositable binder resin results in in good cure performance and appearance compared to a similar electrodepositable coating composition that did not include a mono-functional reactant in making its resin. For example, Composition A includes phenol as a mono-functional reactant and can be compared to composition B that did not include the mono-functional reactant. While both compositions demonstrate good cure performance and edge coverage, Composition B had a rougher surface profile and increased the roughness of the substrate whereas Composition A resulted in a more smooth surface.

The result further demonstrate that the inclusion of the hydroxyl-functional addition polymer allowed for production of an electrodepositable coating composition having good cure performance and good edge coverage without significantly degrading the appearance of the coating. For example, Compositions A and B each include a hydroxyl-functional addition polymer and show relatively similar cure performance and significantly improved edge coverage relative to Comparative Composition C. While each of Compositions A and B had an increase in surface roughness relative to Comparative Composition C, the increase was less pronounced for the coating from Composition A that also included the mono-functional reactant in making the binder resin.

The results also demonstrate that a corrosion inhibitor may be added to improve corrosion performance or improve adhesion to different metal substrates/pretreated surfaces without degrading the appearance, edge coverage or cure performance. For example, Composition H includes yttrium as a corrosion inhibitor and performs similarly to Compositions A and B indicating that the corrosion inhibitor did not degrade the performance of the paint.

TABLE 11

| | Mono- | | | | | | |
|---|---|---|---|---|---|---|---|
| | func. | | | | Ra | | |
| Paint | reactant | CAT | Pigment | EA | (2.5 mm) | Smooth | Burr |
| D | Phenol | Bi-MSA | 100% TiO2 | EA 2 | 0.150 | 75% | 0% |
| E | Phenol | Bi-MSA | 100% TiO2 | EA 3 | 0.156 | 74% | 0% |
| F | Phenol | Bi-MSA | 100% TiO2 | EA 4 | 0.206 | 66% | 24% |
| G | Phenol | Bi-MSA | 100% TiO2 | EA 5 | 0.279 | 54% | 40% |

The results show by example a number of different types of hydroxyl-functional additives may be incorporated into the electrodepositable coating composition. In particular, the higher molecular weight hydroxyl-functional addition polymers provided better edge coverage than lower-molecular weight edge additives. For example, EA 2 and EA 3 have lower molecular weights, whereas EA 4 and EA 5 have higher molecular weights. However, each provide good appearance and smoothing.

It will be appreciated by skilled artisans that numerous modifications and variations are possible in light of the above disclosure without departing from the broad inventive concepts described and exemplified herein. Accordingly, it is therefore to be understood that the foregoing disclosure is merely illustrative of various exemplary aspects of this application and that numerous modifications and variations can be readily made by skilled artisans which are within the spirit and scope of this application and the accompanying claims.

1. An electrodepositable coating composition comprising:
a hydroxyl-functional addition polymer comprising constitutional units, at least 70% of which comprise formula I: 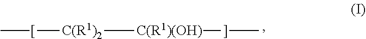
wherein each R¹ is independently one of hydrogen, an alkyl group, a substituted alkyl group, a cycloalkyl group, a substituted cycloalkyl group, an alkylcycloalkyl group, a substituted alkylcycloalkyl group, a cycloalkylalkyl group, a substituted cycloalkylalkyl group, an aryl group, a substituted aryl group, an alkylaryl group, a substituted alkylaryl group, a cycloalkylaryl group, a substituted cycloalkylaryl group, an arylalkyl group, a substituted arylalkyl group, an arylcycloalkyl group, or a substituted arylcycloalkyl group;
an ionic salt group-containing film-forming polymer comprising active hydrogen functional groups;
a blocked polyisocyanate curing agent comprising blocking groups, wherein the blocking groups comprise a 1,2-polyol as a blocking agent; and
a bismuth catalyst.

2. (canceled)

3. The electrodepositable coating composition of claim 1, wherein the constitutional units comprising formula I comprise 70% to 95% of the hydroxyl-functional addition polymer, the % based upon the total constitutional units of the hydroxyl-functional addition polymer.

4. (canceled)

5. The electrodepositable coating composition of claim 1, wherein the hydroxyl-functional addition polymer is formed from polymerizing vinyl ester monomers to form an intermediate polymer comprising constitutional units comprising the residue of vinyl ester, and then hydrolyzing the constitutional units comprising the residue of vinyl ester of the intermediate polymer, wherein the residue of vinyl ester comprises 80% to 100% of the constitutional units comprising the intermediate polymer, the % based upon the total constitutional units of the intermediate polymer.

6-7. (canceled)

8. The electrodepositable coating composition of claim 1, wherein the hydroxyl-functional addition polymer has a theoretical hydroxyl-equivalent weight of 30 g/equivalent of OH to 200 g/equivalent of OH.

9. The electrodepositable coating composition of claim 1, wherein the hydroxyl-functional addition polymer has a theoretical hydroxyl value of 1,000 to 1,300 mg of KOH/g of hydroxyl-functional addition polymer.

10-11. (canceled)

12. The electrodepositable coating composition of claim 1, wherein the ionic salt group-containing film-forming polymer comprises a reaction product of a reaction mixture comprising:
(a) a polyepoxide;
(b) a di-functional chain extender; and
(c) a mono-functional reactant.

13. The electrodepositable coating composition of claim 12, wherein the ratio of functional groups from the di-functional chain extender and the mono-functional reactant to the epoxide functional groups from the polyepoxide may be 0.50:1 to 0.85:1.

14. An electrodepositable coating composition comprising:
an ionic salt group-containing film-forming polymer comprising active hydrogen functional groups, wherein the ionic salt group-containing film-forming polymer comprises a reaction product of a reaction mixture comprising:
(a) a polyepoxide;
(b) di-functional chain extender; and
(c) a mono-functional reactant;
a blocked polyisocyanate curing agent comprising blocking groups, wherein the blocking groups comprise a 1,2-polyol as a blocking agent; and
a bismuth catalyst.

15. (canceled)

16. The electrodepositable coating composition of claim 1, further comprising at least one pigment.

17-19. (canceled)

20. The electrodepositable coating composition of claim 16, wherein the pigment comprises titanium dioxide, barium sulfate, or any combination thereof.

21. The electrodepositable coating composition of claim 20, wherein titanium dioxide is present in an amount of at least 50% by weight, based on the total weight of pigment.

22. The electrodepositable coating composition of claim 20, wherein titanium dioxide is present in an amount of at least 5% by weight, based on the total composition solids weight.

23-32.

33. The electrodepositable coating composition of claim 1, wherein the 1,2-polyol comprises propylene glycol.

34-40. (canceled)

41. The electrodepositable coating composition of claim 1, wherein the bismuth catalyst comprises bismuth methane sulphonate.

42. The electrodepositable coating composition of claim 1, wherein the ionic salt group-containing film-forming polymer comprises a cationic salt group-containing film-forming polymer.

43. The electrodepositable coating composition of claim 1, wherein the ionic salt group-containing film-forming polymer comprises an anionic salt group-containing film-forming polymer.

44-46. (canceled)

47. The electrodepositable coating composition of claim 1, wherein the electrodepositable coating composition further comprises a co-catalyst.

48-56. (canceled)

57. The electrodepositable coating composition of claim 1, further comprising bis[2-(2-butoxyethoxy)ethoxy]methane.

58. A method of coating a substrate comprising electrophoretically applying a coating deposited from an electrodepositable coating composition of claim 1 to at least a portion of the substrate.

59-60. (canceled)

61. A substrate coated with a coating deposited from the electrodepositable coating composition of claim 1 in an at least partially cured state.

62-68. (canceled)
